(19) United States
(12) Patent Application Publication
(10) Pub. No.: US 2026/0181264 A1
(43) Pub. Date: Jun. 25, 2026

(54) CONTROL METHOD AND APPARATUS FOR MEANS OF TRANSPORT, ELECTRONIC DEVICE, AND STORAGE MEDIUM

(71) Applicant: Tencent Technology (Shenzhen) Company Limited, Shenzhen (CN)

(72) Inventor: Yong Yang, Shenzhen (CN)

(21) Appl. No.: 19/537,295

(22) Filed: Feb. 11, 2026

Related U.S. Application Data
(63) Continuation of application No. PCT/CN2024/121293, filed on Sep. 26, 2024.

(30) Foreign Application Priority Data
Oct. 8, 2023 (CN) 202311290335.7

(51) Int. Cl. H04N 23/80; H04N 23/45

(52) U.S. Cl. CPC H04N 23/80; H04N 23/45

(57) ABSTRACT

A method for controlling a means of transport is performed by an electronic device. The method includes: obtaining an environmental image of the means of transport and attribute information of an image receiver; identifying a compliance-related element from the environmental image based on the attribute information; performing compliant adjustment on the environmental image based on the compliance-related element, to obtain a compliant image; and generating a control instruction for the means of transport based on the compliant image.

### CROSS-REFERENCE TO RELATED APPLICATIONS

This application is a continuation application of PCT Patent Application No. PCT/CN2024/121293, entitled “CONTROL METHOD AND APPARATUS FOR MEANS OF TRANSPORT, ELECTRONIC DEVICE, AND STORAGE MEDIUM” filed on Sep. 26, 2024, which claims priority to Chinese Patent Application No. 2023112903357, entitled “REMOTE CONTROL METHOD AND APPARATUS, ELECTRONIC DEVICE, STORAGE MEDIUM, AND PROGRAM PRODUCT” filed on Oct. 8, 2023, all of which are incorporated herein by reference in their entirety.

### FIELD OF THE TECHNOLOGY

This application relates to the field of computer technologies, and specifically, to a control method and apparatus for a means of transport, an electronic device, a storage medium, and a program product.

### BACKGROUND OF THE DISCLOSURE

Remote control is a process of remotely operating and controlling a device, system, or machine through technical means such as wireless communication or network connection, and allows a user to control the device, system, or machine through remote means at different locations and times, without contacting the device, system, or machine, for example, remote control of a means of transport.

When remote control is performed on the means of transport, the user needs to obtain environment information around the means of transport, and transmit a remote control instruction, to ensure safe driving of the means of transport. Usually, the environment information around the means of transport may be obtained through a video, and video content may carry private data of another person. Therefore, there is a leakage risk, leading to low confidentiality of the video.

### SUMMARY

Embodiments of this application provide a control method and apparatus for a means of transport, an electronic device, a storage medium, and a program product.

An embodiment of this application provides a method for controlling a means of transport performed by an electronic device, and including:
obtaining an environmental image of the means of transport and attribute information of an image receiver;
identifying a compliance-related element from the environmental image based on the attribute information;
performing compliant adjustment on the environmental image based on the compliance-related element, to obtain a compliant image; and
generating a control instruction for the means of transport based on the compliant image.

An embodiment of this application provides a method for controlling a means of transport, performed by an electronic device, and including:
obtaining an environmental image of the means of transport, and obtaining attribute information of an image receiver;
identifying a compliance-related element from the environmental image; and
performing compliant adjustment on the environmental image for the compliance-related element based on the attribute information, to obtain a compliant image, the compliant image being configured for generating a control instruction for the means of transport.

This application further provides an electronic device, including a memory and a processor, the memory having a plurality of computer-readable instructions stored therein, and the computer-readable instructions, when executed by the processor, causing the electronic device to perform the operations in the method embodiments of this application.

This application further provides a non-transitory computer-readable storage medium, having a plurality of computer-readable instructions stored therein, the computer-readable instructions, when executed by a processor of an electronic device, causing the electronic device to perform the operations in the method embodiments of this application.

Details of one or more embodiments of this application are set forth in the following accompanying drawings and descriptions. Other features and advantages of this application will be apparent from the description, drawings, and claims.

### BRIEF DESCRIPTION OF THE DRAWINGS

To describe the technical solutions in embodiments of this application or the conventional technology more clearly, the following briefly describes the accompanying drawings required for describing embodiments or the conventional technology. Apparently, the accompanying drawings in the following descriptions are merely embodiments of this application, and a person of ordinary skill in the art may still derive other accompanying drawings from the disclosed accompanying drawings without creative efforts.

FIG. 1 is a schematic diagram of an application scenario of a method for controlling a means of transport according to an embodiment of this application.

FIG. 2 is a schematic diagram of a principle of a method for controlling a means of transport according to an embodiment of this application.

FIG. 3 is a schematic flowchart of a method for controlling a means of transport according to an embodiment of this application.

FIG. 4A is a schematic diagram of a principle of a method for controlling a means of transport according to another embodiment of this application.

FIG. 4B is a schematic diagram of a principle of a method for controlling a means of transport according to another embodiment of this application.

FIG. 5 is a schematic flowchart of performing compliant processing on an object type according to an embodiment of this application.

FIG. 6A is a schematic diagram of a principle of a method for controlling a means of transport according to another embodiment of this application.

FIG. 6B is a schematic diagram of a principle of a method for controlling a means of transport according to another embodiment of this application.

FIG. 7A is a schematic diagram of an overall architecture of a method for controlling a means of transport according to an embodiment of this application.

FIG. 7B is a schematic flowchart of a method for controlling a means of transport according to another embodiment of this application.

FIG. 8 is a schematic diagram of data interaction of a method for controlling a means of transport according to an embodiment of this application.

FIG. 9 is a schematic flowchart of a method for controlling a means of transport according to another embodiment of this application.

FIG. 10 is a schematic diagram of a principle of a method for controlling a means of transport according to another embodiment of this application.

FIG. 11 is a schematic diagram of a principle of a method for controlling a means of transport according to another embodiment of this application.

FIG. 12 is a schematic diagram of data interaction of a method for controlling a means of transport according to another embodiment of this application.

FIG. 13 is a schematic structural diagram of a control apparatus for a means of transport according to an embodiment of this application.

FIG. 14 is a schematic structural diagram of an electronic device according to an embodiment of this application.

### DESCRIPTION OF EMBODIMENTS

The technical solutions in embodiments of this application are clearly and completely described in the following with reference to the accompanying drawings. Apparently, embodiments to be described are merely a part rather than all of embodiments of this application. All other embodiments obtained by a person of ordinary skill in the art based on embodiments of this application without creative efforts shall fall within the protection scope of this application.

Embodiments of this application provide a control method and apparatus for a means of transport, an electronic device, a non-transitory computer-readable storage medium, and a computer program product.

The control apparatus for a means of transport may be specifically integrated into the electronic device, and the electronic device may be a device such as a terminal or a server. The terminal may be a device such as a mobile phone, a tablet computer, a smart Bluetooth device, a laptop computer, a personal computer (PC), a smart voice interaction device, a smart home appliance, a vehicle-mounted terminal, or an aircraft. The server may be a single server, or may be a server cluster including a plurality of severs.

In some embodiments, the control apparatus for a means of transport may alternatively be integrated into a plurality of electronic devices. For example, the control apparatus for a means of transport may be integrated into a plurality of servers, and the plurality of servers implement the method for controlling a means of transport in this application.

In some embodiments, the server may alternatively be implemented in a form of a terminal.

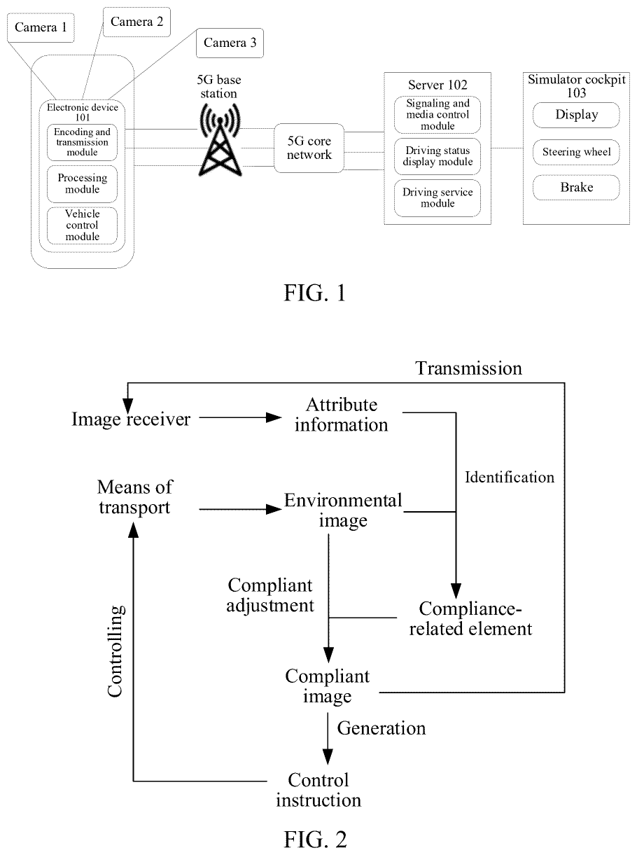

For example, FIG. 1 is a schematic diagram of an application scenario of a method for controlling a means of transport. The application scenario includes an electronic device 101, a server 102, and a simulator cockpit 103. The electronic device 101, the server 102, and the simulator cockpit 103 form a control system. The electronic device 101 may be disposed in the means of transport. The means of transport may be a vehicle, an uncrewed aerial vehicle, an airplane, a ship, or the like. Vehicle may refer to any manned or unmanned conveyance, apparatus, or platform configured to transport persons, animals, cargo, or objects through or across one or more environments, including land, water, air, space, or combinations thereof. For example, in FIG. 1, the electronic device 101 is disposed in the vehicle, and serves as an industrial computer of the vehicle. The electronic device may include an encoding and transmission module, a processing module, and a vehicle control module.

The processing module is responsible for performing compliant processing on an environmental image, to ensure image confidentiality. The encoding and transmission module is configured to encode and transmit a compliant image. The vehicle control module is configured to receive a control instruction, to implement control over the vehicle.

The server 102 may include a signaling and media control module, a driving status display module, and a driving service module. The signaling and media control module is configured to forward an upstream image, a motion parameter of the vehicle, and a downstream control instruction. The driving service module is configured to: receive a control instruction transmitted by a control object through a hardware driver of the simulator cockpit 103, and then deliver the control instruction to a vehicle control module of the electronic device 101 through a network. The control object is an object that controls the means of transport. The driving status display module is responsible for pulling a compliant image and a driving parameter from the signaling and media control module and displaying the compliant image and the driving parameter.

The electronic device 101, the server 102, and the simulator cockpit 103 may transmit data to each other through the network, for example, transmit data to each other through a 5G network. The 5G network may include a 5G base station and a 5G core network. The 5G base station is a wireless access point of the 5G network, and is responsible for transmitting data to user equipment to and receiving data from the user equipment. The 5G core network is a core part of the 5G network, and is responsible for managing and controlling running of the entire network.

The vehicle may be mounted with a plurality of image capture apparatuses, for example, cameras, and may capture environmental information around the vehicle. The electronic device 101 may obtain an environmental image captured by the image capture apparatus, and perform compliant processing, encoding, and transmission on the environmental image.

The control object may initiate a login operation request for driving in the simulator cockpit 103, the login operation request may be verified by the server 102, and after verification succeeds, the server 102 generates a control request for the means of transport, and transmits the control request to the electronic device 101. The electronic device 101 may obtain an environmental image of the means of transport and obtain attribute information of the control object in response to the control request for the means of transport. The control object is an object that controls the means of transport. The electronic device 101 identifies a compliance-related element from the environmental image based on the attribute information of the control object. The electronic device 101 performs compliant adjustment on the environmental image based on a preset element, to obtain the compliant image. The electronic device 101 adjusts a driving status of the means of transport based on a control instruction for the means of transport in response to the control instruction.

In an embodiment, the control method may be a remote control method. The control system including the electronic device 101, the server 102, and the simulator cockpit 103 may be a remote control system. The driving status display module may be a remote driving status display module, and the driving service module may be a remote driving service module. The generated control instruction may be a remote control instruction, and is configured for performing remote control over the means of transport.

The control method may be applied to an intelligent driving scenario, for example, a remote driving scenario or an autonomous driving scenario. For example, in some dangerous environments, the control method may be configured for controlling the vehicle to perform an operation, to reduce an operation risk. For another example, when autonomous driving is abnormal, the control method may be configured for taking over a vehicle with abnormal autonomous driving, to ensure safe driving.

The following separately provides detailed descriptions. A sequence of the following embodiments is not intended to limit preference orders of the embodiments.

In specific implementations of this application, related data such as attribute information, an identifier, and a private key are used. When the above embodiments of this application are applied to a specific product or technology, the permission or consent of a user needs to be obtained, and collection, use, and processing of the related data need to comply with related laws, regulations, and standards of related countries and regions.

In an embodiment, FIG. 2 is a diagram of a principle of a method for controlling a means of transport. An electronic device used in a means of transport is used as an example. The electronic device obtains an environmental image of the means of transport, and obtains attribute information of an image receiver; identifies a compliance-related element from the environmental image based on the attribute information; and performs compliant adjustment on the environmental image based on the compliance-related element, to obtain a compliant image. The compliant image is configured for generating a control instruction for the means of transport. The compliant image may be transmitted to the image receiver, so that the image receiver generates the control instruction for the means of transport based on the compliant image. Alternatively, after obtaining the compliant image, the electronic device may directly generate the control instruction for the means of transport. The means of transport may be controlled based on the control instruction.

In this embodiment, the environmental image of the means of transport and the attribute information of the image receiver are obtained, and the compliance-related element is identified from the environmental image based on the attribute information, to identify a non-compliant element in the environmental image. Compliant adjustment needs to be performed, to adjust the environmental image including the non-compliant element to the compliant image. In this way, private data does not exist in the compliant image received by the image receiver, and confidentiality of the environmental image used in a control scenario of the means of transport is effectively improved. A current driving environment of the means of transport may be learned of based on the compliant image, so that a control instruction for the means of transport in the driving environment can be generated, to control safe driving of the means of transport in the environment, and improve control security.

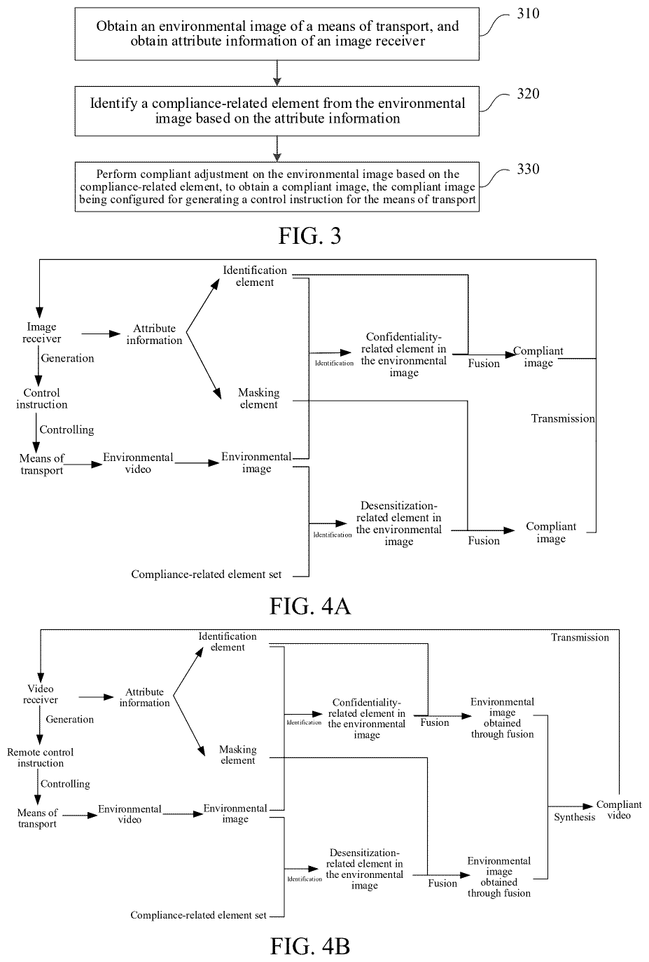

An embodiment provides a method for controlling a means of transport, performed by an electronic device. As shown in FIG. 3, a specific procedure of the control method may be as follows:

310: Obtain an environmental image of the means of transport, and obtain attribute information of an image receiver.

The environmental image is an image related to an environment in which the means of transport is located. The environmental image may exist in a form of a photo/picture, namely, a static image; or exist in a form of a video, namely, a dynamic image; or exist in a form of a combination of a photo/picture and a video (namely, a static image and a dynamic image).

The environmental image may exist in the form of the photo/picture, and may be specifically an image obtained by performing image capture on the environment in which the means of transport is located, or may be an image generated through simulation for an environmental parameter and/or a driving parameter of the means of transport.

An environmental video is a video related to the environment in which the means of transport is located. When the environmental image exists in a form of a video, the environmental image may be an image in the environmental video, and may be specifically a video obtained by performing video capture on the environment in which the means of transport is located, or may be a video generated through simulation for the environmental parameter and/or the driving parameter of the means of transport.

The electronic device may obtain the environmental video of the means of transport, and extract the environmental image from the environmental video.

The image receiver is any user object that can receive the environmental image. For example, the image receiver may be a control object of the means of transport, or may be a requester of a control request for the means of transport, but is not limited thereto. The control request is a request configured for controlling the means of transport.

The control object is an object that controls the means of transport. The control object may be a user who controls the means of transport, or may be an intelligent assistant. For example, the control object may be a user of a simulator cockpit, or may be an intelligent assistant.

The control request may be specifically a remote control request. The remote control request is a request configured for remotely controlling the means of transport.

The attribute information may include at least one of the following: information such as credibility of the image receiver, an identifier of the image receiver, a device identifier of the image receiver, and an object type of the image receiver.

The electronic device may obtain the environmental image of the means of transport, and determine the image receiver of the environmental image. The electronic device may obtain the attribute information of the image receiver.

In this embodiment, the electronic device may transmit an attribute obtaining request to the image receiver, and the image receiver receives the attribute obtaining request, and feeds back the attribute information to the electronic device.

In another embodiment, the electronic device may prestore a plurality of image receivers and attribute information of each image receiver. The electronic device may select the image receiver of the environmental image from the plurality of stored image receivers, and obtain the attribute information of the image receiver.

In an embodiment, the obtaining an environmental image of the means of transport includes: obtaining the environmental image of the means of transport in response to the control request for the means of transport.

In an embodiment, the obtaining an environmental image of the means of transport includes: obtaining an environmental video of the means of transport in response to a remote control request for the means of transport; and extracting the environmental image from the environmental video.

In an embodiment, the control request may include attribute information of the control object, and the control object is an object that controls the means of transport.

The control request may carry the attribute information of the control object. The attribute information may include at least one of the following: information such as an identifier of the control object, an identifier of a device that initiates the control request, and an object type of the control object.

In some implementations, to ensure confidentiality of control, the control request may be generated after the control object is authenticated. For example, the control object may perform a login operation in the simulator cockpit, to transmit a login request to a server. The login request may include an identifier of a to-be-controlled means of transport, the identifier of the control object, and a corresponding key. The server may perform authentication based on the identifier and the key, and after authentication succeeds, transmit the control request to an electronic device corresponding to the means of transport based on the identifier of the means of transport. Therefore, the electronic device may receive the control request of the control object for the means of transport.

In some embodiments, after receiving the control request for the means of transport, the electronic device may obtain the environmental image of the means of transport.

In some embodiments, after receiving the control request for the means of transport, the electronic device may obtain the environmental video of the means of transport. The environmental video may include a plurality of frames of environmental images.

When obtaining the environmental image, the electronic device may issue a capture instruction to an image capture module on the means of transport. After receiving the capture instruction, the image capture module continuously captures the environmental image within a capture range, generates the environmental image based on the captured environmental image, and transmits the environmental image to the electronic device. Therefore, the electronic device may obtain the environmental image of the means of transport.

In some implementations, the environmental image may be obtained through capture by a plurality of image capture apparatuses. For example, there are two image capture apparatuses, capture ranges of the two image capture apparatuses are adjacent but do not overlap, and each image capture apparatus may transmit a captured image to the electronic device. The electronic device may stitch images captured at the same moment, to obtain the environmental image; and generate an environmental video based on a plurality of frames of environmental images.

In some implementations, the environmental image is obtained through simulation for the environmental parameter and/or the driving parameter of the means of transport.

In this embodiment, the environmental image is obtained through simulation for the environmental parameter of the means of transport. For example, the electronic device may collect an environmental parameter of the environment in which the means of transport is located, simulate the environment of the means of transport based on the environmental parameter, perform image capture on the simulated environment, and generate the environmental image of the means of transport based on a captured image.

In this embodiment, the environmental image is obtained through simulation for the driving parameter of the means of transport. The electronic device may collect the driving parameter of the means of transport, simulate a driving environment of the means of transport based on the driving parameter, perform image capture on the simulated environment, and generate the environmental image of the means of transport based on a captured image.

In this embodiment, the environmental image is obtained through simulation for the environmental parameter and the driving parameter of the means of transport. For example, the electronic device may collect an environmental parameter of the environment in which the means of transport is located and a driving parameter of the means of transport in the environment, simulate a driving environment of the means of transport based on the environmental parameter and the driving parameter, perform image capture on the simulated environment, and generate the environmental image of the means of transport based on a captured image. The environmental video of the means of transport may be further generated based on the captured image.

In this embodiment, the environmental image is obtained through simulation for the environmental parameter and/or the driving parameter of the means of transport, and the driving environment of the means of transport is simulated based on at least one of the environmental parameter or the driving parameter of the means of transport. An environmental image obtained through simulation has a smaller amount of unrelated data than an actually captured environmental image. Therefore, in subsequent processing of the environmental image, a small amount of data needs to be analyzed and processed, and a speed of performing compliant adjustment on the environmental image can be improved.

In some implementations, the environmental video is obtained through simulation for the environmental parameter and/or the driving parameter of the means of transport.

320: Identify a compliance-related element from the environmental image based on the attribute information.

The compliance-related element is an element on which compliant processing needs to be performed to meet a compliance requirement. For example, the compliance-related element may be an element related to sensitive data in the environmental image, may be an element on which confidential processing needs to be performed in the environmental image, or may be an element that does not conform to a traffic rule in the environmental image.

The environmental image is captured by the image capture apparatus on the means of transport. Usually, private data such as a pedestrian and a license plate number of another vehicle may appear in an environment around the means of transport, and the private data may also appear in the captured environmental image. If the environmental image is directly transmitted to any control object, the private data may be leaked. After the image is spread, it is difficult to trace a source, leading to poor confidentiality of the environmental image.

The private data may be masked, to improve the confidentiality of the environmental image. In an application, the private data is detected as a compliance-related element, and the compliance-related element needs to be masked.

The electronic device may identify the compliance-related element from the environmental image based on the attribute information of the image receiver. The compliance-related element is a related element on which compliant processing needs to be performed in the environmental image, so that the environmental image is legal and compliant.

In this embodiment, the electronic device may obtain a preset element having a mapping relationship with the attribute information, and identify the compliance-related element from the environmental image based on the preset element, or identify the compliance-related element from the environmental image based on the preset element and the attribute information.

The preset element includes at least one of an identification element or a masking element. The masking element is an element configured for eliminating a to-be-masked object in the environmental image, and the identification element is an element configured for tracing a source of the environmental image. The compliance-related element includes at least one of a confidentiality-related element or a desensitization-related element. Both eliminating the private data in the environmental image by using the masking element and marking a source of the environmental image by using the identification element can improve the confidentiality of the environmental image.

In some embodiments, the electronic device may select, as the identification element from a plurality of preset elements, an element that can mark an image or an image source, and select, as the masking element, an element having a masking function.

In some embodiments, the preset element configured for performing compliant processing on the environmental image may be determined based on the object type of the image receiver. For example, a mapping relationship between a preset object type and a preset element may be obtained, and the preset element onto which the object type is mapped is obtained based on the mapping relationship, and is used as the preset element configured for performing compliant processing on the environmental image.

The mapping relationship between a preset object type and a preset element may be preset, and the preset object type may include a plurality of object types such as a trusted type and an untrusted type. The preset element may include the identification element, the masking element, and the like. The identification element may be configured for tracing the source of the environmental image, and the masking element may be configured for masking the private data in the environmental image.

In an implementation, the object type of the image receiver may be included in the attribute information, and the object type is determined by the server. After obtaining the attribute information, the electronic device may directly obtain the object type, to determine the preset element onto which the object type is mapped in the mapping relationship.

In an implementation, the same control object has different object types in different means of transport. For example, for a vehicle A, an object type of a control object A is a trusted type; and for a vehicle B, the object type of the control object A is an untrusted type. The electronic device may determine the object type based on the attribute information of the control object. For example, the electronic device is disposed in the means of transport, the electronic device stores a preset list corresponding to the means of transport, and the preset list records an object identifier of a trusted object corresponding to the means of transport. Therefore, the electronic device may directly obtain an object identifier of the control object from the attribute information, and determine the object type of the control object based on the object identifier and the preset list. For example, when the object identifier is in the preset list, the object type of the control object is a trusted type. When the object identifier is not in the preset list, the object type of the control object is an untrusted type.

In an implementation, the attribute information may carry the object type, and the object type may be determined by the server. The electronic device may alternatively determine the object type based on the attribute information. The electronic device may alternatively comprehensively determine the object type of the control object based on the object type carried in the attribute information and the object type determined by the electronic device. For example, the object type carried in the attribute information is recorded as a first type, and the object type determined by the electronic device is recorded as a second type. To be specific, when both the first type and the second type are trusted types, the object type of the control object may be determined as a trusted type; or when the first type and the second type are not trusted types, the object type of the control object is determined as an untrusted type.

After the object type is determined, the preset element corresponding to the object type in the mapping relationship may be determined for use in subsequent compliant processing. For example, when the object type is a trusted type, the identification element may be determined as the preset element; or when the object type is an untrusted type, the identification element and the masking element may be determined as preset elements.

In this embodiment, setting the mapping relationship between an object type and a preset element can set respective preset elements for different types of objects. In this way, the preset element is set in a targeted manner. An element onto which the object type is mapped is found based on the mapping relationship, and is used as the element for performing compliant adjustment on the environmental image. In this way, the preset element is queried more quickly and more accurately, to help improve a speed and quality of compliant adjustment on the environmental image.

330: Perform compliant adjustment on the environmental image based on the compliance-related element, to obtain a compliant image, the compliant image being configured for generating a control instruction for the means of transport.

Compliant adjustment is to adjust a non-compliant element in the environmental image to a compliant element, to obtain the compliant image. The compliance-related element is the non-compliant element in the environmental image.

The compliance-related element may be specifically an element that does not conform to the traffic rule or laws and regulations in the environmental image. For example, a driving route of the means of transport in the environmental image does not conform to the traffic rule, or a parking location of the means of transport does not conform to the traffic rule. Compliant adjustment may be to adjust the element that does not conform to the traffic rule in the environmental image, so that the adjusted element conforms to the traffic rule or related laws and regulations.

The compliance-related element may be an element that has a data security risk in the environmental image. The data security risk means a leakage risk, low confidentiality, difficult source tracing, or another case. For example, the compliance-related element may be an element related to personal privacy, sensitive information, source tracing information, and the like in the environmental image.

Compliant adjustment may be processing such as keeping the private data in the environmental image confidential, desensitizing the sensitive data, or marking a source tracing identifier in the environmental video, to eliminate the data security risk in the environmental image.

In this embodiment, the electronic device may perform compliant adjustment on the environmental image based on the compliance-related element, to obtain the compliant image. Further, the electronic device may perform compliant adjustment on the environmental image based on the attribute information and the compliance-related element, to obtain the compliant image.

In this embodiment, the performing compliant adjustment on the environmental image based on the attribute information and the compliance-related element, to obtain the compliant image includes: grading the attribute information, to obtain a compliant processing level of the attribute information; and performing compliant adjustment on the environmental image based on the compliant processing level and the compliance-related element.

One compliant processing level may correspond to one compliant adjustment manner, and different compliant adjustment manners have different adjustment degrees. The electronic device may determine the compliant adjustment manner corresponding to the compliant processing level, and perform compliant adjustment on the environmental image in the compliant adjustment manner and the compliance-related element, to obtain the compliant image.

For example, the compliant processing level may be a first level, a second level, and a third level. The first level corresponds to a first compliant adjustment manner, the second level corresponds to a second compliant adjustment manner, and the second level corresponds to a third compliant adjustment manner. An adjustment degree of the first compliant adjustment manner may be greater than an adjustment degree of the second compliant adjustment manner, and the adjustment degree of the second compliant adjustment manner may be greater than an adjustment degree of the third compliant adjustment manner.

For example, the first compliant adjustment manner is to perform compliant adjustment on both the confidentiality-related element and the desensitization-related element, the second compliant adjustment manner is to perform compliant adjustment on the desensitization-related element, and the third compliant adjustment manner is to perform compliant adjustment on the confidentiality-related element.

In this embodiment, a compliant adjustment manner and an adjustment degree of performing compliant adjustment on the environmental image may be determined based on the attribute information, to perform compliant processing in the compliant adjustment manner and degree, so that compliant adjustment is more targeted, to reduce unnecessary data processing, and improve data processing efficiency.

In this embodiment, the performing compliant adjustment on the environmental image based on the attribute information and the compliance-related element, to obtain the compliant image includes: classifying the attribute information, to obtain an attribute information category corresponding to the attribute information; determining a compliant processing level based on the attribute information category; and performing compliant adjustment on the environmental image based on the compliance-related element and the compliant processing level, to obtain the compliant image.

Classifying may be performed based on a preset attribute information classification manner. Attribute information categories to which different attribute information belongs are preset, and one attribute information category may correspond to one compliant processing level.

In this embodiment, the attribute information category corresponding to the attribute information may be determined, to determine a level of compliant processing that needs to be performed on the environmental image. A specific level of compliant processing can be performed based on a category of the attribute information of the image receiver, so that compliant adjustment is more targeted, to reduce unnecessary data processing.

After obtaining the compliant image, the electronic device may forward the compliant image to the image receiver, and the image receiver may play the compliant image, so that the user can learn of environmental information around the means of transport. Certainly, after the compliant image is played, the image receiver may alternatively generate the control instruction or a remote control instruction based on the compliant image, and return the control instruction or the remote control instruction to the electronic device. The electronic device adjusts the driving status of the means of transport based on the control instruction or the remote control instruction, to implement control over the means of transport.

In some embodiments, the preset element includes the identification element, and the compliance-related element includes the confidentiality-related element. The electronic device determines a confidentiality-related element corresponding to the identification element in the environmental image, and performs compliant adjustment on the environmental image based on the identification element and the confidentiality-related element, to obtain the compliant image.

In an embodiment, the identification element and the confidentiality-related element in the environmental image may be fused, to obtain the compliant image.

In some embodiments, the preset element includes the masking element, and the compliance-related element includes the desensitization-related element. The electronic device determines a desensitization-related element corresponding to the masking element in the environmental image, and performs compliant adjustment on the environmental image based on the masking element and the desensitization-related element, to obtain the compliant image.

In an embodiment, the desensitization-related element in the environmental image may be masked by using the masking element, to obtain the compliant image. Further, the masking element and the desensitization-related element in the environmental image are fused, to obtain the compliant image.

In some embodiments, the preset element includes the identification element and the masking element, and the compliance-related element includes the confidentiality-related element and the desensitization-related element. The electronic device may determine a confidentiality-related element corresponding to the identification element in the environmental image, determine a desensitization-related element corresponding to the masking element in the environmental image, fuse the identification element and the confidentiality-related element in the environmental image, and fuse the masking element and the desensitization-related element in the environmental image, to obtain the compliant image.

FIG. 4A is a schematic diagram of a principle of a method for controlling a means of transport according to an embodiment. An electronic device obtains an environmental image of the means of transport, obtains attribute information of an image receiver, and obtains an identification element and a masking element that have a mapping relationship with the attribute information. A confidentiality-related element in the environmental image is identified based on the identification element, and a desensitization-related element in the environmental image is identified based on a preset compliance-related element set. The identification element and the confidentiality-related element in the environmental image are fused, to obtain an environmental image obtained through fusion. The masking element and the desensitization-related element in the environmental image are fused, to obtain a compliant image. The electronic device transmits the compliant image to the image receiver, and the image receiver generates a control instruction for the means of transport based on the compliant image, and transmits the control instruction to the electronic device, to implement control over the means of transport.

In some embodiments, as shown in FIG. 4B, an electronic device obtains an environmental video of a means of transport, extracts a plurality of frames of environmental images from the environmental video, obtains attribute information of an image receiver, and obtains an identification element and a masking element that have a mapping relationship with the attribute information. A confidentiality-related element in the environmental image is identified based on the identification element, and a desensitization-related element in the environmental image is identified based on a preset compliance-related element set. The identification element and the confidentiality-related element in the environmental image are fused, to obtain an environmental image obtained through fusion. The masking element and the desensitization-related element in the environmental image are fused, to obtain a compliant image. All frames of compliant images are synthesized, to obtain a compliant video. The electronic device transmits the compliant video to the image receiver, and the image receiver generates a remote control instruction for the means of transport based on the compliant video, and transmits the remote control instruction to the electronic device, to implement remote control over the means of transport.

In this embodiment, performing compliant adjustment on the environmental image based on a preset element, to obtain a compliant image includes: obtaining a preset element having a mapping relationship with the attribute information; and performing compliant adjustment on the environmental image based on a compliance-related element in the environmental image and the preset element, to obtain the compliant image.

The environmental video may include a plurality of frames of environmental images, and a compliance-related element may be identified from each frame of environmental image. The compliance-related element is a region in which the preset element is located in the environmental image when the preset element is fused into the environmental image.

As described above, the preset element may include the identification element. After the identification element is added to the environmental image, a source of the environmental image may be traced. For example, an environmental image a seen by an image receiver A includes an identification element corresponding to the image receiver A. Therefore, after the environmental image a is illegally spread, source tracing may be performed based on the identification element. The identification element may be related to an identifier of the image receiver. A representation form of the identification element may be an image. For example, the identification element may be an image generated based on the identifier of the image receiver.

In an embodiment, the preset element includes the identification element and the masking element, and the compliance-related element includes the confidentiality-related element and the desensitization-related element. Identifying the compliance-related element from the environmental image based on the attribute information includes: separately identifying the confidentiality-related element corresponding to the identification element and the desensitization-related element corresponding to the masking element from the environmental image based on the attribute information.

The performing compliant adjustment on the environmental image based on a compliance-related element in the environmental image and the preset element, to obtain the compliant image includes: performing compliant adjustment on the environmental image based on the identification element and the corresponding confidentiality-related element, and the masking element and the corresponding desensitization-related element that are in each frame of environmental image, to obtain the compliant image. Specifically, the identification element and the confidentiality-related element in the environmental image may be fused, and the masking element and the desensitization-related element in the environmental image may be fused, to obtain the compliant image.

In this embodiment, an image source is marked in the environmental image by using the identification element, to reduce a risk that the compliant image is legally spread, thereby effectively protecting the image and improving confidentiality of the image. In addition, efficient source tracing may be performed after the compliant image is legally spread. In addition, private data in the environmental image is masked by using the masking element, so that the private data in the image can be eliminated, user privacy is effectively protected, confidentiality of the environmental image can be enhanced, and confidentiality of the image can also be enhanced.

In some implementations, the preset element includes a plurality of identification elements, and a compliance-related element corresponding to the preset element includes a confidentiality-related element corresponding to the identification element.

Identifying the compliance-related element from the environmental image based on the attribute information includes: determining an arrangement rule of the plurality of identification elements for the environmental image; and determining confidentiality-related elements respectively corresponding to the plurality of identification elements in the environmental image based on the arrangement rule for the environmental image and the plurality of identification elements.

A plurality of identification elements may be added to one environmental image, and the arrangement rule is a rule that needs to be satisfied by a distribution of the plurality of identification elements in the environmental image. Arrangement rules corresponding to all environmental images may be the same. In other words, the same arrangement rule may be used for all the environmental images. For example, the arrangement rule may be a left diagonal arrangement. To be specific, the identification elements are arranged from an upper left corner of the environmental image to a lower right corner at a specified spacing, where the upper left corner is used as an arrangement start point. In this case, in each frame of environmental image, the identification elements are distributed in a left diagonal manner.

The arrangement rules of all the environmental images may be different, to further improve confidentiality of the environmental image. For example, an arrangement rule corresponding to the first environmental image is a diagonal arrangement, and an arrangement rule corresponding to the second environmental image is a right diagonal arrangement. To be specific, the identification elements are arranged from an upper right corner of the environmental image to a lower left corner at a specified spacing, where the upper right corner is used as an arrangement start point.

When an arrangement rule of the plurality of identification elements for each frame of environmental image in the environmental video is determined, each frame of environmental image in the environmental video may be numbered, to obtain a frame number corresponding to each frame of environmental image. A total quantity of identification elements is determined, the frame number corresponding to the frame environmental image is obtained, the total quantity of random locations are generated based on the frame number, and a distribution of the total quantity of random locations in the environmental image is used as the arrangement rule of the total quantity of identification elements for the frame environmental image.

After the environmental image is numbered, the frame number corresponding to each frame of environmental image may be obtained. It is assumed that a quantity of identification elements to be added to each frame of environment image is the total quantity. The frame number is used as a seed value, and the total quantity of random locations are generated by using a pseudorandom number generator. The pseudorandom number generator may be a linear congruential generator, a Mersenne twister algorithm, or the like, and may be specifically selected according to an actual requirement.

In some implementations, an arrangement rule base may be further pre-established. The arrangement rule base may include a plurality of arrangement rules. For each frame of environmental image, one arrangement rule is randomly selected from the arrangement rule base, to obtain the arrangement rule of the plurality of identification elements for each frame of environmental image.

For each frame of environmental image, the electronic device may determine the confidentiality-related elements respectively corresponding to the plurality of identification elements from the environmental image based on the arrangement rule for the environmental image and the plurality of identification elements. One identification element corresponds to one confidentiality-related element.

In this embodiment, the arrangement rule of the plurality of identification elements for the environmental image is determined; and the confidentiality-related elements respectively corresponding to the plurality of identification elements are identified in the environmental image based on the arrangement rule for the environmental image and the plurality of identification elements. In this way, a source of the environmental image can be marked by using the identification element, to improve security of the environmental image.

In this embodiment, when a source of each frame of environmental image in the environmental video needs to be marked, the arrangement rule of the plurality of identification elements for each frame of environmental image is determined. For each frame of environmental image, the confidentiality-related elements respectively corresponding to the plurality of identification elements are identified in the environmental image based on the arrangement rule for the environmental image and the plurality of identification elements. In this way, the plurality of identification elements may be arranged in the environmental image based on different arrangement rules, so that the source of the environmental image is marked in a plurality of manners, to improve security of each frame of environmental image in the environmental video.

In an embodiment, the identifying confidentiality-related elements respectively corresponding to the plurality of identification elements in the environmental image based on the arrangement rule for the environmental image and the plurality of identification elements includes: arranging the plurality of identification elements in the environmental image based on the arrangement rule for the environmental image, to obtain an arranged environmental image; and determining that regions respectively overlapping the plurality of identification elements in the arranged environmental image are the confidentiality-related elements respectively corresponding to the plurality of identification elements.

When there are a plurality of frames of environmental images, because the plurality of identification elements have an arrangement rule for each frame of environmental image, for each frame of environmental image, the plurality of identification elements may be arranged in the environmental image based on the arrangement rule for the environmental image, to obtain the arranged environmental image. The arranged environmental image includes the plurality of identification elements, and some regions in the arranged environmental image overlap the identification elements. Therefore, a region overlapping one identification element can be directly determined as a confidentiality-related element corresponding to the identification element, to obtain the confidentiality-related elements respectively corresponding to the plurality of identification elements.

In this embodiment, for each frame of environmental image, the plurality of identification elements are arranged in the environmental image based on the arrangement rule for the environmental image, to obtain an image including the plurality of identification elements. Regions respectively overlapping the plurality of identification elements in the arranged environmental image are determined as the confidentiality-related elements respectively corresponding to the plurality of identification elements. In this way, confidentiality-related elements of the plurality of identification elements in different environmental images can be identified based on the arrangement rule, so that an image source of each frame of environmental image in the environmental image is marked based on different arrangement rules. There are more complex and diversified source marking manners, and the source of each frame of environmental image can be traced, so that the environmental video and each frame of image in the environmental video are kept confidential, and security is higher.

In some embodiments, the preset element includes the masking element, the compliance-related element includes the desensitization-related element, and identifying the compliance-related element from the environmental image based on the attribute information includes:
obtaining a masking element having a mapping relationship with the attribute information, and identifying a desensitization-related element corresponding to the masking element from the environmental image.

The preset element may include the masking element. After being added to the environmental image, the masking element may mask the private data in the environmental image. The private data is used as a to-be-masked object. For example, if a picture of a license plate number of another vehicle exists in the environmental image, the license plate number may be masked by using the masking element, to avoid leakage of private data of another person. The masking element may be a preset image matching the private data. For example, if the private data is a license plate number, the masking element may be a rectangle. For example, if the private data is a face of a pedestrian, the masking element may be a circle.

When the preset element includes the masking element, the compliance-related element corresponding to the preset element may include the desensitization-related element corresponding to the masking element. During determining of the compliance-related element corresponding to the preset element, a to-be-masked object corresponding to the masking element may be detected in each frame of environmental image, and the to-be-masked object in each frame of environmental image is determined as the desensitization-related element corresponding to the masking element.

The desensitization-related element is the to-be-masked object in the environmental image, namely, an object to be masked by the masking element in the environmental image. The electronic device may detect each frame of environmental image, to detect the to-be-masked object existing in each frame of environmental image. The to-be-masked object is content that needs to be masked in the environmental image, for example, may be a pedestrian, or may be a license plate number of another vehicle.

In other words, image detection needs to be performed on the environmental image, to detect the to-be-masked object in the environmental image. A trained detection network may be used, and the detection network may identify the to-be-masked object in the environmental image. For example, when the to-be-masked object is the pedestrian and the license plate number, a sample image and a sample label corresponding to the sample image may be first obtained. The sample image may be an image including the pedestrian, an image including the license plate number, or an image including the pedestrian and the license plate number, and the sample label is location information of the pedestrian, the license plate number, or the pedestrian and the license plate number in the image.

The detection network may be a convolutional neural network. The sample image may be input into the convolutional neural network, to predict a location of the to-be-masked object, and obtain predicted location information. A loss function may be obtained based on a difference between the predicted location information and the sample label. A network parameter of the convolutional neural network is adjusted, to continuously reduce the difference between the predicted location information and the sample label, so that the loss function converges. When the loss function converges, the detection network may be obtained.

During actual detection of the to-be-masked object, each frame of environmental image may be input into the detection network, and a to-be-masked object detected by the detection network is determined as a desensitization-related element. If there is no to-be-masked object in a frame of environmental image, there is no corresponding desensitization-related element. Certainly, in some implementations, the preset element may be the masking element and the identification element, and the compliance-related element includes the desensitization-related element and the confidentiality-related element. In this case, the to-be-masked object may be detected in each frame of environmental image in the foregoing manner, to obtain the desensitization-related element, and the confidentiality-related element is determined based on the arrangement rule for the environmental image. If there is no to-be-masked object in a frame of environmental image, there is no corresponding desensitization-related element. To be specific, in the environmental image, both the desensitization-related element and the confidentiality-related element may exist, or only the confidentiality-related element exists.

In this embodiment, the to-be-masked object corresponding to the masking element is detected in the environmental image, to detect an object that needs to be masked in the environmental image. The to-be-masked object in the environmental image is determined as the desensitization-related element corresponding to the masking element, so that a location that needs to be masked in the environmental image can be determined, to mask the private data in the environmental image and improve security of the private data.

In an embodiment, the preset element includes a plurality of identification elements and masking elements, and the compliance-related element includes a plurality of confidentiality-related elements and desensitization-related elements. Determining the compliance-related element corresponding to the preset element from each frame of environmental image includes:
determining an arrangement rule of the plurality of identification elements for each frame of environmental image; for each frame of environmental image, determining confidentiality-related elements respectively corresponding to the plurality of identification elements in the environmental image based on the arrangement rule for the environmental image and the plurality of identification elements; and detecting a to-be-masked object corresponding to the masking element in each frame of environmental image, and determining that a region in which the to-be-masked object is located in the environmental image is a desensitization-related element corresponding to the masking element. The confidentiality-related elements respectively corresponding to the plurality of identification elements in each frame of environmental image are determined based on the arrangement rule of the plurality of identification elements in each frame of environmental image. In this way, the plurality of identification elements may be arranged in the environmental image based on different arrangement rules, so that the source of the environmental image is marked in a plurality of manners, to improve security of each frame of environmental image in the environmental video. Private data in each frame of environmental image is masked by using the masking element, to eliminate the private data in each frame of environmental image, and effectively protect user privacy.

After the compliance-related element is determined, compliant processing may be performed on the environmental image based on the compliance-related element and the preset element. Compliant processing is processing for improving confidentiality of the environmental image, and may be fusing the preset element into the compliance-related element in the environmental image.

In some implementations, if the preset element is the identification element, and the compliance-related element is the confidentiality-related element, when compliant processing is performed, transparency of the identification element may be adjusted to preset transparency, to obtain an adjusted identification element; the adjusted identification element is superimposed onto the confidentiality-related element, to obtain a compliant image; and a compliant video is obtained based on all compliant images.

The identification element may be configured for tracing a source of the environmental image or the environmental video. Therefore, when the identification element is fused into the environmental image, the identification element cannot mask original content in the environmental image. Therefore, the transparency of the identification element may be directly adjusted to the preset transparency, to obtain the adjusted identification element. The transparency is visibility of the identification element in the environmental image. Higher transparency indicates higher visibility of the identification element, and lower transparency indicates lower visibility of the identification element. The transparency may be usually represented by using a value between 0 and 1.0 represents completely transparent, namely, invisible, and 1 represents completely non-transparent, namely, completely visible.

If the identification element is completely visible, the original content in the environmental image is masked. Therefore, the preset transparency may be set to a value having low visibility, for example, 0.3 or 0.4. Specifically, the preset transparency may be set according to an actual requirement, and an identification element having the preset transparency is the adjusted identification element. After the adjusted identification element is obtained, the identification element may be directly placed on the confidentiality-related element to implement fusion, to obtain the compliant image; and then, all the compliant images are fused, to obtain the compliant video.

In some embodiments, the performing compliant adjustment on the environmental image based on a compliance-related element in the environmental image and the preset element, to obtain the compliant image includes:
performing a frequency-domain transform on the identification element, to obtain an adjusted identification element; and fusing the adjusted identification element and the confidentiality-related element in the environmental image, to obtain the compliant image.

In this embodiment, the environmental video includes a plurality of frames of environmental images; each frame of compliant video may be obtained by performing compliant adjustment on each frame of environmental image in the foregoing manner; and all frames of compliant images are synthesized, to obtain a compliant video.

The frequency-domain transform is to transform the identification element from a spatial domain into a frequency domain. Specifically, a frequency-domain transform may be performed through a Fourier transform, a wavelet transform, or the like. For example, the identification element is transformed into a specified frequency domain through a Fourier transform, to obtain an adjusted identification element.

The electronic device may fuse the adjusted identification element and the confidentiality-related element in the environmental image, to obtain a compliant image. Further, all frames of compliant images are synthesized, to obtain a compliant video.

In this embodiment, the frequency-domain transform is performed on the identification element, to transform the identification element from the spatial domain to the specified frequency domain, to improve robustness and confidentiality of the identification element. The adjusted identification element and the confidentiality-related element in the environmental image are fused, to obtain a compliant image whose source is marked by using the identification element.

In addition, a compliant video whose source is marked may be obtained by synthesizing all frames of compliant images whose sources are marked.

In an embodiment, the fusing the adjusted identification element and the confidentiality-related element in the environmental image, to obtain the compliant image includes:
performing a frequency-domain transform on the confidentiality-related element in the environmental image, to obtain a transformed region image; fusing the adjusted identification element and the transformed region image, to obtain a region-fused image; and transforming the region-fused image into a spatial domain, to obtain the compliant image.

In the environmental image, there may be a plurality of confidentiality-related elements. Therefore, an image in each confidentiality-related element needs to be fused with the adjusted identification element. Fusion of an image in one confidentiality-related element and the adjusted identification element is described in detail below.

A part of images of the environmental image exists in the confidentiality-related element, and a frequency-domain transform may be performed on the image in the confidentiality-related element, to obtain a transformed image. The frequency-domain transform is performed in the same manner as the foregoing frequency-domain transform performed on the identification element, and a transform into the same frequency domain is performed. In other words, the adjusted identification element and the transformed image are frequency-domain images in the same frequency domain.

In the frequency-domain image, a value of each pixel represents intensity and phase information of a corresponding frequency component, and a frequency domain coefficient is a value at each pixel in the frequency-domain image. For a two-dimensional image, the frequency domain coefficient is usually in a form of a complex number, and includes a real part and an imaginary part. The frequency-domain image may be regarded as a matrix including the frequency domain coefficient. Therefore, when the adjusted identification element and the transformed image are fused, a frequency domain coefficient of the adjusted identification element may be added to a frequency domain coefficient of the transformed image, to obtain a region-fused image.

In an implementation, the adjusted identification element and the transformed image may be fused in a weighted summation manner. For example, the weighted summation manner may be represented by using the following formula: y=α*x1+β*x2. Herein, y represents the region-fused image, x1 represents the frequency domain coefficient of the adjusted identification element, a represents a weight corresponding to the adjusted identification element, x2 represents the frequency domain coefficient of the transformed image, and β represents a weight corresponding to the transformed image. α and β may be set according to an actual requirement.

Then, the region-fused image is transformed into the spatial domain, to obtain a fused environmental image. For example, the region-fused image may be transformed into the spatial domain through an inverse Fourier transform, an inverse wavelet transform, and the like, to obtain a compliant image.

In this embodiment, the frequency-domain transform is performed on the confidentiality-related element in the environmental image, so that robustness and confidentiality of the confidentiality-related element can be improved. The adjusted identification element and the transformed region image are fused, to obtain the region-fused image, and the region-fused image is transformed into the spatial domain, to obtain the compliant image, so that the compliant image includes an identification element related to a control object, to reduce a risk of legally spreading the compliant image, effectively protect the image, and improve image confidentiality. A source may be efficiently traced after the compliant image is legally spread.

In this embodiment, all the compliant images are synthesized, to obtain the compliant video. In this embodiment, the frequency-domain transform is performed on the confidentiality-related element in each frame of environmental image, so that robustness and confidentiality of the confidentiality-related element can be improved. The adjusted identification element and the transformed region image are fused, to obtain the region-fused image, the region-fused image is transformed into the spatial domain, to obtain the fused environmental image, and all the frames of images are synthesized, to obtain the compliant video, so that the compliant video includes an identification element related to a control object, to reduce a risk of legally spreading the compliant video, effectively protect the video, and improve video confidentiality. A source may be efficiently traced after the compliant video is legally spread.

In some embodiments, the performing compliant adjustment on the environmental image based on a compliance-related element in the environmental image and the preset element, to obtain the compliant image includes:
blurring the desensitization-related element in the environmental image based on the masking element, to obtain the compliant image.

In this embodiment, all frames of compliant images are synthesized, to obtain the compliant image.

Because the desensitization-related element is a region in which the to-be-masked object is located in the environmental image, the desensitization-related element may exist in a part of the environmental image. For an environmental image in which a to-be-masked region exists, the desensitization-related element may be blurred by using the masking element, to obtain a blurred environmental image. The masking element may be configured for masking the to-be-masked object, and may be presented as that the desensitization-related element is blurred and cannot be clearly seen. The masking element may be generated in the desensitization-related element through blurring, or may be an image.

When the masking element is generated in the desensitization-related element through blurring, the desensitization-related element is blurred, to generate the masking element in the desensitization-related element, and obtain the blurred environmental image. Optionally, the desensitization-related element may be divided into a plurality of sub-regions; for each sub-region, a sub-region pixel average value is calculated based on pixel values of all pixels in the sub-region; and the pixel values of all the pixels in the sub-region are updated based on the sub-region pixel average value, to generate the masking element in the desensitization-related element, and obtain the blurred environmental image.

For example, the desensitization-related element is divided into three sub-regions. For each sub-region, pixel values of all pixels in the sub-region may be obtained, and an average value of the pixels in the sub-region is calculated, to obtain a sub-region pixel average value. Then, the pixel values of all the pixels in the sub-region are updated to the sub-region pixel average value, to generate the masking element in the desensitization-related element.

When the masking element is a specific image, the desensitization-related element may be blurred by using the masking element, to obtain the blurred environmental image. Optionally, the masking element may directly cover the desensitization-related element, so that the masking element covers the original environmental image.

In this embodiment, the desensitization-related element in the environmental image is blurred based on the masking element, to obtain the compliant image. In this way, private data of another person in the environmental image can be masked.

In addition, all frames of compliant images are synthesized, to obtain a compliant video that does not include the private data of the another person. In this way, privacy of the another person is effectively protected.

In some embodiments, the blurring the desensitization-related element in the environmental image based on the masking element, to obtain the compliant image includes:
fusing the identification element and the confidentiality-related element in the environmental image, to obtain a fused image; obtaining boundary information of the desensitization-related element for the fused environmental image; correcting boundary information of the masking element based on the boundary information of the desensitization-related element in the environmental image, to obtain a corrected masking element; and covering a to-be-masked region in the environmental image with the corrected masking element, to obtain the compliant image.

The boundary information of the desensitization-related element includes at least one of color information or shape information of the desensitization-related element.

The boundary information of the masking element includes at least one of color information or shape information of the masking element.

For the fused environmental image, the color information of the desensitization-related element is obtained; a color of the masking element may be corrected based on the color information of the desensitization-related element; and a shape of the masking element may be corrected based on the shape information of the desensitization-related element, to obtain the corrected masking element. The to-be-masked region in the environmental image is covered with the corrected masking element, to obtain the compliant image.

In this embodiment, for the fused environmental image, the boundary information of the desensitization-related element is obtained, and the boundary information of the masking element is corrected based on the boundary information of the desensitization-related element in the environmental image, so that a boundary of the corrected masking element fits a boundary of the desensitization-related element, and the corrected masking element can completely cover the desensitization-related element in the environmental image. In this way, the private data of the another person is accurately masked. In addition, the boundary of the corrected masking element fits the boundary of the desensitization-related element, so that the masking element is more naturally fused into the environmental image, to improve a visual effect.

In some embodiments, the blurring the desensitization-related element in the environmental image based on the masking element, to obtain the compliant image includes:
obtaining color information and shape information of the desensitization-related element in the environmental image; adjusting a shape and a color of the masking element based on the shape information and the color information of the desensitization-related element in the environmental image, to obtain a corrected masking element; and covering the desensitization-related element in the environmental image with the corrected masking element, to obtain the compliant image.

In this embodiment, for each frame of environmental image, color information and shape information of a desensitization-related element in the environmental image are obtained; a shape and a color of the masking element are adjusted based on the shape information and the color information of the desensitization-related element in the environmental image, to obtain a corrected masking element; and the desensitization-related element in the environmental image is covered with the corrected masking element, to obtain a blurred environmental image.

The electronic device may obtain the color information and the shape information of the desensitization-related element in the environmental image, adjust the shape of the masking element based on the shape information of the desensitization-related element in the environmental image, and adjust the color of the masking element based on the color information in the environmental image, to obtain the corrected masking element.

In this embodiment, a sequence of adjusting the shape and the color of the masking element is not limited. The shape may be adjusted before the color, or the color may be adjusted before the shape. For example, the electronic device obtains the color information and the shape information of the desensitization-related element; adjusts the shape of the masking element based on the shape information, to obtain the adjusted masking element; corrects the color of the adjusted masking element based on the color information, to obtain the corrected masking element; or adjusts the color of the masking element based on the color information, to obtain the adjusted masking element; and corrects the shape of the adjusted masking element based on the shape information, to obtain the corrected masking element.

The boundary information is information that represents the boundary of the desensitization-related element in the environmental image, and may include the color information and the shape information of the boundary. The color information is a color of the boundary. A closed region surrounded by the boundary is the desensitization-related element, and the color of the boundary is not a single color. For example, a right side of the boundary may be yellow, and a left side of the boundary may be green. The shape information is a shape of the boundary, for example, a circle, a sector, or a rectangle.

Because the masking element is a specific image, the masking element has a shape. For example, the masking element may be a black circular image. After the color information and the shape information are obtained, the shape of the masking element may be adjusted based on the shape information. For example, if the shape information of the boundary is a rectangle, the masking element may be adjusted from a circle to a rectangle, so that the masking element matches the shape information of the boundary, to avoid masking an image in a non-desensitization-related element.

In addition, the color of the masking element may be corrected based on the color information. For example, the color information is a single color. For example, if the color of the rectangular boundary is red, the color of the entire masking element may be directly changed from black to red, to obtain a corrected masking element.

If the color information of the boundary includes at least two colors, in some implementations, a target color may be determined based on proportions of the two colors at the boundary, and then the color of the masking element is adjusted to the target color. For example, the color information includes yellow and green. A proportion of yellow at the entire boundary is 30%, and a proportion of green at the entire boundary is 70%. A color having a highest proportion may be directly determined as the target color. In other words, the color of the masking element may be directly adjusted to green, to obtain a corrected masking element.

In some implementations, if the color information of the boundary includes at least two colors, a transition color may be generated based on the color information, and then the color of the masking element is adjusted to the transition color. The transition color is not a single color but a gradient color from light to dark. For example, if a left side and an upper side of a rectangle are yellow, and a right side and a lower side are green, the color of the masking element may be a gradient color from yellow to light yellow, and from light yellow to light green and finally to green. A gradient direction is from an upper left side to a lower right side, to obtain a corrected masking element.

After the corrected masking element is obtained, the corrected masking element may directly cover the desensitization-related element, to mask an image in the desensitization-related element, obtain a blurred environmental image, and avoid leakage of the private data.

As described above, a preset object may include a pedestrian and a license plate number, and the masking element may be the same image, for example, a mosaic image. Certainly, for different preset objects, the masking elements may also be presented differently. When the desensitization-related element is detected, a type of the preset object in the desensitization-related element may be correspondingly detected. When the desensitization-related element is determined, the type of the preset object in the desensitization-related element may be marked. For example, when the preset object is a pedestrian, the desensitization-related element carries a specified identifier, a smiling face image may be used as a masking element of a desensitization-related element that carries the specified identifier, and a mosaic image is used as a masking element of a desensitization-related element that does not carry the specified identifier. This may be specifically set according to an actual requirement, and is not specifically limited herein.

After compliant processing is performed on each frame of environmental image, a corresponding compliant image may be obtained, so that a compliant video may be obtained. In other words, the compliant video includes a plurality of frames of compliant images.

In this embodiment, the color information and the shape information of the desensitization-related element in the environmental image are obtained, to adjust the shape of the masking element based on the shape information of the desensitization-related element, and adjust the color of the masking element based on the color information of the desensitization-related element, so that the adjusted masking element can accurately mask the private data in the environmental image, and can be more naturally fused into the environmental image in terms of the shape and the color. In this way, the visual effect is improved.

In some implementations, if the preset element includes the identification element and the masking element, the compliance-related element includes the confidentiality-related element and the desensitization-related element. Compliant processing may be performed on the environmental image by using the confidentiality-related element and the corresponding identification element and by using the desensitization-related element and the corresponding masking element by combining the foregoing two manners, to obtain a compliant image. In addition, a plurality of frames of compliant images may be synthesized, to obtain a compliant video.

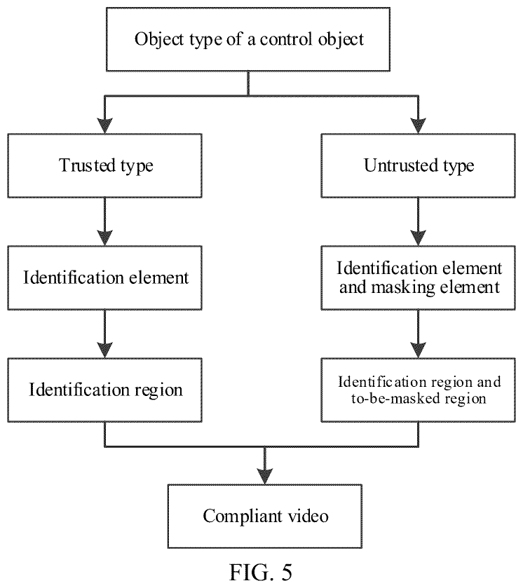

To describe the foregoing image processing process in more detail, FIG. 5 is a schematic flowchart of performing compliant processing based on an object type. If it is determined that the object type of the control object is a trusted type, the identification element may be determined as a preset element, the confidentiality-related element is determined in the environmental image as a compliance-related element, and the identification element is fused into the confidentiality-related element in each frame of environmental image, so that a compliant image can be obtained.

If it is determined that the object type of the control object is an untrusted type, the identification element and the masking element may be determined as preset elements, and the confidentiality-related element and the desensitization-related element are determined in the environmental image as compliance-related elements. If a desensitization-related element exists in the environmental image, the identification element is fused into the confidentiality-related element in each frame of environmental image, and the masking element is fused into the desensitization-related element; or if no desensitization-related element exists in the environmental image, the identification element is fused into the confidentiality-related element in each frame of environmental image, to obtain a compliant image.

Certainly, because the masking element may be configured for masking a pedestrian or a license plate number, the untrusted type may be further subdivided into a high or low untrusted degree. For example, when the object type is determined with reference to both the object type, namely, the first type carried in the attribute information and the object type, namely, the second type determined by the electronic device as described above, an untrusted degree of the object type may be determined to be low when only one of the first type and the second type is an untrusted type; or an untrusted degree of the object type is determined to be high when both the first type and the second type are untrusted types. When the untrusted degree is high, both the pedestrian and the license plate number may be masked by using the masking element; or when the untrusted degree is low, one of the pedestrian and the license plate number may be selected to be masked.

In some implementations, a specific preset object that needs to be masked may be further preset by the user. For example, if the user chooses to mask only the pedestrian, only a region in which the pedestrian is located is subsequently determined as a desensitization-related element; or if the user chooses to mask only the license plate number, only a region in which the license plate number is located is subsequently determined as a desensitization-related element. This may be specifically selected or set according to an actual requirement, and is not specifically limited herein.

For a control object of the trusted type, compliant processing is performed based on an identification element related to the control object. After an image is legally spread, a source may be quickly traced, and a risk that the image is legally spread may be reduced, to effectively protect the image and improve confidentiality of the image.

For a control object of the untrusted type, compliant processing is performed based on both the identification element and the masking element. In this way, a risk of leakage of private data of another person can be reduced. The masking element may mask private data in an image, to effectively avoid data leakage. In addition, the identification element can be configured for source tracing. A source of the image can be quickly identified after data leakage, to effectively improve confidentiality of the image.

In some embodiments, the method further includes: adjusting a driving status of the means of transport based on a remote control instruction for the means of transport in response to the remote control instruction.

After obtaining the compliant image, the electronic device may forward the compliant image to the image receiver, and the image receiver may play the compliant image, so that the user can learn of environmental information around the means of transport. When the image receiver includes a control object of the means of transport, after the compliant image is received by the image receiver, the control object may alternatively transmit a remote control instruction based on the compliant image. In response to the remote control instruction, the electronic device adjusts the driving status of the means of transport based on the remote control instruction, so that the control object implements remote control over the means of transport.

In an implementation, the method further includes: obtaining the driving parameter of the means of transport; encoding the compliant image, to obtain an image-encoded data; transmitting the driving parameter and the image-encoded data to a server, to display the driving parameter and the compliant image to the image receiver; and obtaining, through the server, a control instruction generated by the image receiver based on the driving parameter and the compliant image, and adjusting the driving parameter of the means of transport based on the control instruction, to adjust a driving status of the means of transport.

In this embodiment, after the compliant video is obtained, the compliant video is encoded, to obtain video-compressed data. The video-compressed data includes image-encoded data. The driving parameter and the video-compressed data are sent to the server, to present the driving parameter and the compliant video to the image receiver, so as to obtain a control instruction or a remote control instruction. The server obtains the control instruction, and adjusts a current driving parameter of the means of transport based on the control instruction, to adjust the driving status of the means of transport.

Alternatively, the server obtains the remote control instruction, and adjusts the current driving parameter of the means of transport based on the remote control instruction, to adjust the driving status of the means of transport.

During remote control over the means of transport, not only a surrounding environment of the means of transport needs to be presented in real time, but also the driving parameter of the means of transport needs to be learned of, to ensure more accurate remote control. To reduce a data transmission amount in remote control, the electronic device may obtain the driving parameter of the means of transport. The driving parameter of the means of transport may include a speed, an acceleration, a consumption status of energy, and the like. The electronic device may obtain the driving parameter from a sensor disposed on the means of transport. For example, after obtaining the compliant image, the electronic device may transmit an instruction to a speed sensor, an acceleration sensor, an energy detector, and the like, to obtain the driving parameter of the means of transport.

When the compliant image is transmitted, to reduce a data transmission amount of the compliant image, the compliant image may be encoded, to obtain encoded data, and then the encoded data and the current driving parameter are transmitted to the server, to present the current driving parameter and the compliant image to the control object. After being encoded, the compliant image becomes the encoded data, and the encoded data can be decoded to restore the compliant image.

When the compliant video is transmitted, to reduce a data transmission amount of the compliant video, the compliant video may be encoded, to obtain encoded data, and then the encoded data and the current driving parameter are transmitted to the server, to present the current driving parameter and the compliant video to the control object. After being encoded, the compliant video becomes the encoded data, and the encoded data can be decoded to restore the compliant video.

Therefore, the control object may transmit a corresponding remote control instruction. The remote control instruction may be forwarded by the server to the electronic device, so that the electronic device may adjust the driving parameter of the means of transport based on the remote control instruction, to change the moving status of the means of transport.

Encoding the compliant image may reduce a size of image data and maintain high visual quality.

In an embodiment, the electronic device is mounted on the means of transport. Before the obtaining an environmental image of the means of transport, the method further includes: receiving a control request initiated by the control object for the means of transport through a simulator cockpit; and
after the performing compliant adjustment on the environmental image based on the compliance-related element, to obtain a compliant image, the method further includes: transmitting the compliant image to the simulator cockpit; and receiving a control instruction initiated by the control object through the simulated driving, the control instruction being generated by the control object after the control object browses the compliant image in the simulated driving.

In this embodiment, the simulator cockpit may be configured for remotely controlling the means of transport. The control object may control, in the simulator cockpit, the simulator cockpit to generate the remote control request for the means of transport. The remote control request includes the attribute information of the control object. The control object transmits the remote control request to the electronic device in the means of transport by using the simulator cockpit.

The electronic device receives the remote control request, and automatically captures the environmental image of the means of transport. The electronic device obtains the attribute information of the control object from the remote control request. The electronic device identifies the compliance-related element in the environmental image based on the attribute information of the control object. The electronic device performs compliant adjustment on the environmental image based on the compliance-related element, to obtain the compliant image.

The electronic device transmits the compliant image to the simulator cockpit, and the control object may play and browse the compliant image in the simulator cockpit. When browsing the compliant image, the control object may control the simulator cockpit to generate the remote control instruction and transmit the remote control instruction to the electronic device. The electronic device receives the remote control instruction, and adjusts the moving status of the means of transport based on the remote control instruction.

In this embodiment, compliant adjustment may be performed on the environmental image in the environmental video, to obtain the compliant video; the compliant video includes the plurality of frames of compliant images; the compliant image is transmitted to the simulator cockpit; the control instruction or the remote control instruction initiated by the control object through the simulated driving is received; and the control instruction or the remote control instruction is generated by the control object after the control object browses the compliant video in the simulated driving.

In this embodiment, when receiving the remote control request initiated by the user, the electronic device mounted on the means of transport automatically captures an environment around the means of transport to generate an image or a video, and automatically performs compliant adjustment on the environmental image or the environmental image in the environmental video, to protect private data in the video and the image. After being adjusted, the video and the image is transmitted to the user, so that after viewing the image or video, the user may transmit the remote control instruction in a targeted manner to control driving of the means of transport, thereby improving security of data in the image or the video, and ensuring safety of remote driving.

In some embodiments, the encoding the compliant image, to obtain an image-encoded data includes:
analyzing a plurality of frames of compliant images in the compliant video, and determining a frame type of each frame of compliant image; encoding, when a frame type of a compliant image is a preset type, the compliant image based on a spatial correlation between pixels in the compliant image, to obtain image-encoded data; and encoding, when a frame type of a compliant image is not the preset type, the compliant image based on temporal repeatability of all frames of compliant images that are not of the preset type, to obtain image-encoded data.

When the compliant video is encoded, the frame type corresponding to each compliant image may be first determined. The frame type may include a key type and a non-key type. For example, a motion vector between adjacent frames, for example, a motion vector between a current frame and a previous frame, may be estimated based on a motion estimation algorithm. The motion vector may be configured for describing a vector value of a movement status of an object or scene in a video between two consecutive frames. The frame type of the current frame is determined as a key type if the motion vector is greater than a preset threshold. Currently, a frame type of a first frame of the video is also of a key type. Therefore, in this manner, the frame type corresponding to each frame of compliant image may be determined.

The preset type may be a key type. To be specific, for a compliant image of a key type, the compliant image may be encoded based on a spatial correlation within the compliant image. In the compliant image, adjacent pixels usually have similar colors, textures, or grayscale values. This means that the adjacent pixels has a spatial correlation. Therefore, redundant information can be reduced based on the correlation between the adjacent pixels in the compliant image, to achieve a better compression ratio.

If the frame type of the compliant image is not the preset type, for a compliant image of a non-key type, a motion vector between adjacent frames is small. In other words, repeatability between compliant images of the non-key type is high. A non-key frame and a key frame exist after the key frame, and the non-key frame is determined with reference to a previous frame of the non-key frame. For example, if the first frame and the fifth frame are key frames, the second frame to the fourth frame have small differences from previous frames. For an image of a non-key type, there is no need to encode each frame, and only a difference needs to be encoded. For example, when the second frame is encoded, only a difference between the second frame and the first frame may be encoded, to reduce redundant information and achieve a higher compression ratio. Image-encoded data corresponding to all images is determined as the video-compressed data. The compliant video is transmitted by transmitting the video-compressed data, so that a data transmission amount can be effectively reduced, and a response speed of remote control can be improved.

After receiving the video-compressed data, the server or the simulator cockpit may restore, in a corresponding decoding manner, the video-compressed data to the compliant video for playing.

The control object is located in the simulator cockpit, and the simulator cockpit is a simulated driving hardware system having a display, a steering wheel, a brake, and the like. After encoding the compliant video to obtain the video-compressed data, the electronic device may transmit the video-compressed data and the driving parameter to the server through a network. The server may transmit the video-compressed data and the driving parameter to the simulator cockpit. Certainly, the server may also transmit the video-compressed data and the driving parameter to another display device, to present a driving status of the means of transport in remote driving to another user.

The video-compressed data and the driving parameter may be displayed on the display in the simulator cockpit. The control object may transmit the remote control instruction by using the steering wheel, the brake, or the like, and transfer the remote control instruction to the electronic device through the server, to adjust the driving parameter of the means of transport, so that the driving status of the means of transport changes.

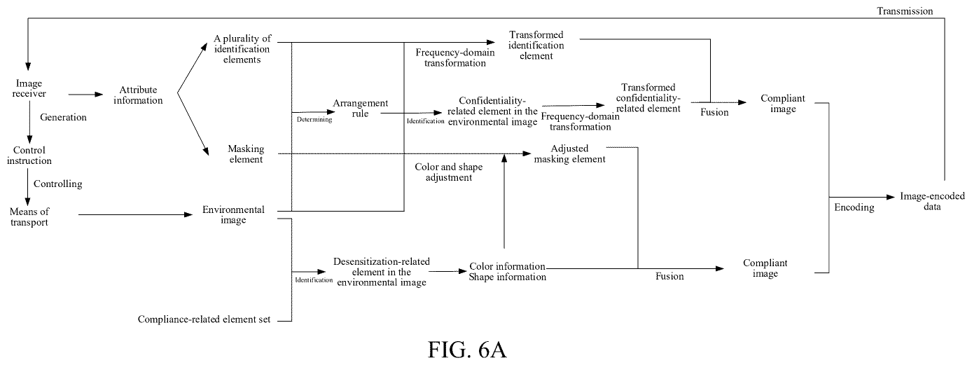

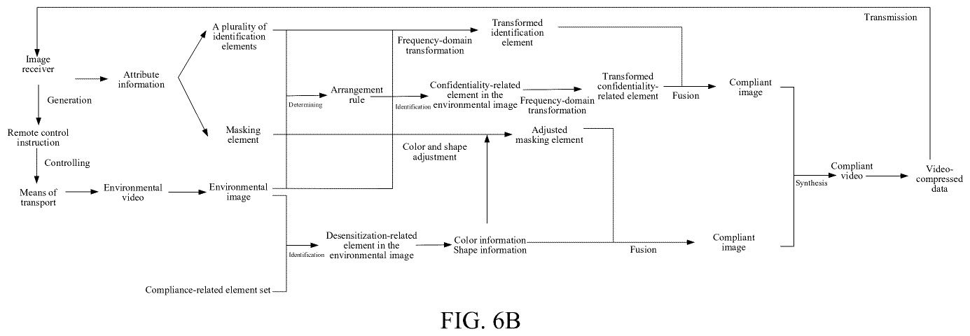

In an embodiment, FIG. 6A is a schematic diagram of a principle of a method for controlling a means of transport.

An electronic device obtains an environmental image of the means of transport, and obtains attribute information of an image receiver; obtains a plurality of identification elements and a masking element that have a mapping relationship with the attribute information; determines an arrangement rule of the plurality of identification elements for the environmental image, and identifies a confidentiality-related element corresponding to each identification element from the environmental image based on the arrangement rule of the plurality of identification elements for the environmental image; and performs a frequency-domain transform on each identification element and the confidentiality-related element in the environmental image, and fuses an identification element obtained through the frequency-domain transform with a confidentiality-related element obtained through the frequency-domain transform in the environmental image, to obtain a compliant image.

A desensitization-related element in the environmental image is identified based on a preset compliance-related element set. Color information and shape information of the desensitization-related element are obtained; a color of the masking element is adjusted based on the color information of the desensitization-related element, and a shape of the masking element is adjusted based on the shape information of the desensitization-related element, to obtain a corrected masking element. The corrected masking element and the desensitization-related element in the environmental image are fused, to obtain a compliant image.

The compliant image is encoded, to obtain an image-encoded data. A driving parameter of the means of transport is obtained, and the image-encoded data and the driving parameter are transmitted to the image receiver. The image receiver generates a control instruction for the means of transport based on the image-encoded data and the driving parameter, and transmits the control instruction to the electronic device. The electronic device adjusts the driving parameter of the means of transport based on the control instruction, to adjust a driving status of the means of transport. In this way, control of the image receiver over the means of transport is implemented.

In an embodiment, FIG. 6B is a schematic diagram of a principle of a method for controlling a means of transport.

An electronic device obtains an environmental video of the means of transport, and obtains attribute information of an image receiver; obtains a plurality of identification elements and a masking element that have a mapping relationship with the attribute information; extracts a plurality of frames of environmental images from the environmental video, determines an arrangement rule of the plurality of identification elements for the environmental image, and identifies a confidentiality-related element corresponding to each identification element from the environmental image based on the arrangement rule of the plurality of identification elements for the environmental image; and performs a frequency-domain transform on each identification element and the confidentiality-related element in the environmental image, and fuses an identification element obtained through the frequency-domain transform with a confidentiality-related element obtained through the frequency-domain transform in the environmental image, to obtain a compliant image.

A desensitization-related element in the environmental image is identified based on a preset compliance-related element set. Color information and shape information of the desensitization-related element are obtained; a color of the masking element is adjusted based on the color information of the desensitization-related element, and a shape of the masking element is adjusted based on the shape information of the desensitization-related element, to obtain a corrected masking element. The corrected masking element and the desensitization-related element in the environmental image are fused, to obtain a compliant image.

All frames of compliant images are synthesized, to obtain a compliant video. The compliant video is encoded, to obtain video-compressed data. A driving parameter of the means of transport is obtained, and the video-compressed data and the driving parameter are transmitted to the image receiver. The image receiver generates a remote control instruction for the means of transport based on the video-compressed data and the driving parameter, and transmits the remote control instruction to the electronic device. The electronic device adjusts the driving parameter of the means of transport based on the remote control instruction, to adjust a driving status of the means of transport. In this way, remote control of the image receiver over the means of transport is implemented.

This embodiment provides the method for controlling a means of transport, performed by the electronic device. The environmental video of the means of transport and the attribute information of the image receiver are obtained, and the compliance-related element is identified from the environmental video based on the attribute information, to identify a non-compliant element in the environmental video. Compliant adjustment needs to be performed, to adjust the environmental video including the non-compliant element to the compliant video. In this way, private data does not exist in the compliant video received by the image receiver, and confidentiality of the environmental video used in a remote control scenario of the means of transport is effectively improved. A current driving environment of the means of transport may be learned of based on the compliant video, so that a remote control instruction for the means of transport in the driving environment can be generated, to control safe driving of the means of transport in the environment, and improve remote control security.

In addition, an object that controls the means of transport may trigger the remote control instruction after viewing the compliant video, and the electronic device adjusts the driving status of the means of transport based on the remote control instruction. In this way, not only remote control of the object over the means of transport can be implemented, but also leakage of private data in a remote control process of the means of transport can be avoided. In addition, private data does not exist in the compliant video seen by the object that controls the means of transport, thereby effectively improving confidentiality of an environmental video used in a remote control scenario of the means of transport.

To describe the method for controlling a means of transport more clearly, FIG. 6A and FIG. 6B are schematic diagrams of an overall architecture of a method for controlling a means of transport. An example in which the means of transport is a vehicle is used. The means of transport mainly includes a server end and a vehicle end. The vehicle end may include a capture module and an electronic device, and the electronic device may include a vehicle control module, a processing module, and an encoding and transmission module. The server end may include a signaling and media control module, a driving status display module, and a driving service module. Functions of the modules are described in detail below.

The capture module is responsible for capturing environmental images or environmental videos of a plurality of image capture apparatuses deployed on the vehicle and providing the environmental images or environmental videos to the processing module in a fixed format such as a YUV format.

The processing module is responsible for performing compliant processing on the environmental image or an environmental image in the environmental video, transforming the environmental image into a compliant image, and transforming the environmental video into a compliant video. That is, the processing module is responsible for performing operations 320 to 330.

The encoding and transmission module is responsible for encoding the compliant image to obtain image-encoded data, and transmitting the image-encoded data to a server through a network; and is further responsible for encoding the compliant video to obtain video-compressed data, and transmitting the video-compressed data to the server through the network. The network may be a wireless local area network, a cellular network, a satellite communication network, a dedicated communication network, or the like.

The vehicle control module is responsible for obtaining a motion parameter of the vehicle in an upstream direction and transmitting the motion parameter to the driving status display module through the network; and receiving, in a downstream direction from the network, a control instruction delivered by the driving service module to the vehicle control module, to control a moving status of the vehicle.

The signaling and media control module is configured to forward an upstream video-compressed data, the motion parameter of the vehicle, and a downstream remote control instruction.

The driving status display module is responsible for pulling the image-encoded data or the video-compressed data from the signaling and media control module, and receiving the upstream motion parameter of the vehicle for displaying.

The driving service module is responsible for receiving a control instruction or a remote control instruction transmitted by a control object by using a simulator cockpit hardware driver, and then delivering the control instruction or the remote control instruction to the vehicle control module through the network.

The method for controlling a means of transport provided in this embodiment of this application may be applied to various remote driving scenarios. For example, remotely driving the vehicle is used as an example. In the control method provided in this embodiment of this application, in a process of remotely driving the vehicle, compliant processing is performed on an environmental video at the vehicle end, to obtain video-compressed data, and then transmit the video-compressed data to the server. Compared with a case in which a video is transmit to a server or a cloud and the server or the cloud performs compliant processing, in this way, a data processing amount is further reduced, to ensure video confidentiality and improve a response speed of remote control.

According to the method provided in this embodiment of this application, when a remote control request is received, an environmental video of the means of transport may be obtained, a preset element having a mapping relationship with attribute information of a control object is obtained based on the attribute information, and a compliance-related element is identified from an environmental image in the environmental video. Compliant adjustment is performed on a compliance-related element in each frame of environmental image based on the compliance-related element in each frame of environmental image and a preset element, to obtain a compliant video. This protects private data in the environmental video and avoids data leakage, thereby effectively improving confidentiality of the video. Finally, the remote control instruction is obtained based on the compliant video, and a moving status of the means of transport is adjusted based on the remote control instruction, to implement remote control.

Compared with a manner in which the video is transmitted to the server or the cloud for compliant processing, to be specific, the video is encoded and then transmitted to the server, and the server decodes the video, performs compliant processing, encodes the video, and transmits the encoded video to a remote control end, in this embodiment of this application in which compliant processing on the video is performed on a means of transport side, repeated encoding and decoding may be avoided, and an end-to-end video transmission delay is reduced, thereby reducing a delay of remote control and improving a response speed of the remote control. Therefore, in this embodiment of this application, both the response speed and video confidentiality can be considered in remote control.

According to the method described in the foregoing embodiments, the following further provides detailed descriptions.

In an embodiment, an example in which an electronic device is integrated into a vehicle to perform remote control over the vehicle is configured for describing the method in this embodiment of this application in detail.

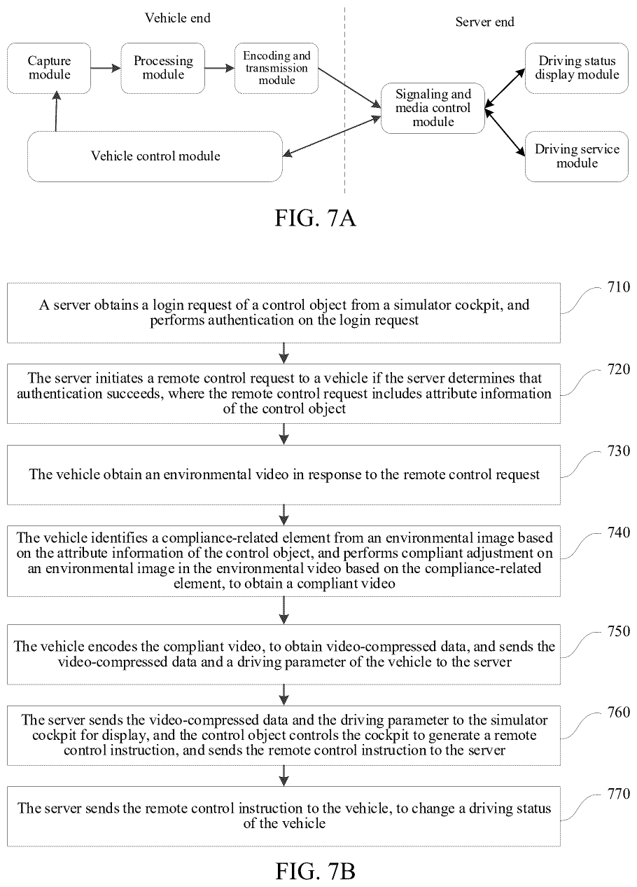

As shown in FIG. 7B, a specific procedure of a method for controlling a means of transport is as follows:

710: A server obtains a login request of a control object from a simulator cockpit, and performs authentication on the login request.

720: The server initiates a remote control request to the vehicle if the server determines that authentication succeeds, where the remote control request includes attribute information of the control object.

730: The vehicle obtains an environmental video in response to the remote control request, where the environmental video includes a plurality of frames of environmental images.

740: The vehicle identifies a compliance-related element from the environmental image based on the attribute information of the control object, and performs compliant adjustment on the environmental image in the environmental video based on the compliance-related element, to obtain a compliant video.

750: The vehicle encodes the compliant video, to obtain video-compressed data, and transmits the video-compressed data and a driving parameter of the vehicle to the server

760: The server transmits the video-compressed data and the driving parameter to the simulator cockpit for display, and the control object controls the cockpit to generate a remote control instruction, and transmits the remote control instruction to the server.

770: The server transmits the remote control instruction to the vehicle, to change a driving status of the vehicle.

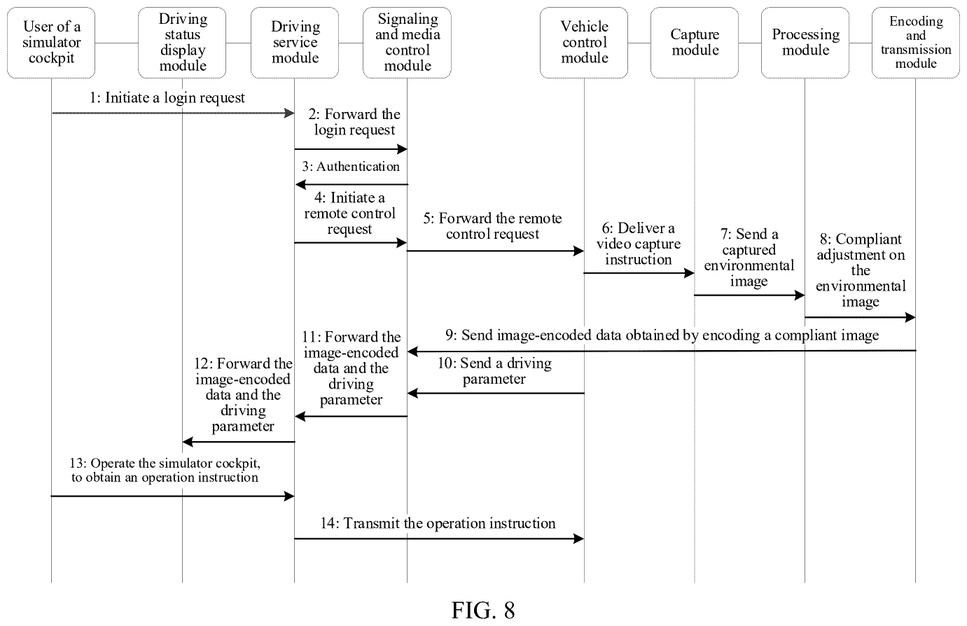

For operations 710 to 770, mutual reference may be made to content in the foregoing embodiments. To describe the specific procedure of the method for controlling a means of transport more clearly, FIG. 8 is a schematic diagram of data interaction of a control method. Detailed descriptions are provided below with reference to FIG. 8.

A vehicle control module, a capture module, a processing module, and an encoding and transmission module are all deployed on a vehicle. The capture module may capture images or videos of a plurality of cameras deployed on the vehicle, and provide the images or videos to the processing module in a fixed format such as a YUV format.

A driving status display module, a driving service module, and a signaling and media control module are all deployed on a server or cloud.

1. A user of a cockpit, namely, a control object initiates a login request for remote driving in a simulator cockpit. The login request includes a vehicle number ID-a, an identifier of the control object, and a corresponding key. The login request is transmitted to the driving service module.

2. The driving service module forwards the login request to the media and signaling control module.

3. The signaling and media control module completes authentication on the login request, and returns a response to the driving service module.

4. The driving service module starts to initiate a remote control request for a vehicle numbered ID-a to the signaling and media control module.

5. The signaling and media control module forwards the remote control request to a vehicle control module numbered ID-a. The remote control request carries the identifier of the control object and a user type (a trusted type or a non-trusted type).

6. The vehicle control module issues a capture instruction to the capture module, to capture an environmental image or an environmental video of the means of transport.

7. The capture module starts to start, and transmits the captured environmental image or environmental video to the processing module.

8. The processing module starts compliant adjustment of the environmental image, or performs compliant adjustment on an environmental image in the environmental video. If the user type is a trusted type, only a watermark is processed, to be specific, only an identification element is added to the environmental image; or if the user type is not a trusted type, a watermark is added to the video, and video desensitization is performed (to be specific, both the identification element and a masking element are added to the environmental image).

9. A compliant image obtained through processing is transmitted to the encoding and transmission module, and the encoding and transmission module encodes and compresses the compliant image, to obtain image-encoded data, and then transmits the image-encoded data to the signaling and media control module of the server through a network. Alternatively, a compliant video obtained through processing is transmitted to the encoding and transmission module, and the encoding and transmission module performs compression and encoding, to obtain video-compressed data, and then transmits the video-compressed data to the signaling and media control module of the server through a network. If only one person needs to view the compliant image or the compliant video, the image-encoded data or the video-compressed data obtained through encoding and compression may alternatively be directly transmitted to the driving service module, without being forwarded by the signaling and the media control module.

10. In this case, the vehicle control module also starts to transmit a driving parameter of the vehicle to the signaling and media control module of the server.

11. The signaling and media control module transmits the image-encoded data and the driving parameter to the driving service module, or transmits the video-compressed data and the driving parameter to the driving service module.

12. The driving service module transmits the image-encoded data and the driving parameter to the status display module together, and the status display module presents a compliant image of a camera of a vehicle end and driving status data of the vehicle on a display. Alternatively, the driving service module transmits the video-compressed data and the driving parameter to the status display module together, and the status display module presents a compliant video of a camera of a vehicle end and driving status data of the vehicle on a display.

13. The user of the simulator cockpit operates the simulator cockpit based on the image-encoded data and the driving parameter to start remote driving, and obtains an operation instruction for the simulator cockpit. The user of the simulator cockpit may further operate the simulator cockpit based on the video-compressed data and the driving parameter to start remote driving, and obtain an operation instruction for the simulator cockpit.

14. The operation instruction received by the driving service module is transmitted to the vehicle control module at the vehicle end through the signaling and control module at the cloud, and the vehicle control module controls vehicle driving through a CAN bus, to change a driving status of the vehicle.

Whether to perform desensitization may be determined based on an object type of the control object. Desensitization is performed according to a requirement, to avoid random leakage of private data of another person. In addition, a watermark related to the control object is added to the environmental video or the environmental image, to reduce a risk that the video or the image is legally spread. After the video or the image is legally spread, a source of the video may be quickly identified, thereby ensuring confidentiality of the video or the image. Compliant processing on the video or the image is performed on the vehicle end, and the server does not need to perform any processing. In this way, a video or image transmission delay can be reduced, and a response speed of remote control can be improved.

An embodiment provides a method for controlling a means of transport, performed by an electronic device. As shown in FIG. 9, a specific procedure of the control method may be as follows:

910: Obtain an environmental image of the means of transport, and obtain attribute information of an image receiver.

The electronic device may obtain the environmental image of the means of transport, and determine the image receiver of the environmental image. The electronic device may obtain the attribute information of the image receiver.

In this embodiment, the electronic device may transmit an attribute obtaining request to the image receiver, to obtain the attribute information fed back by the image receiver.

In another embodiment, the electronic device may prestore a plurality of image receivers and attribute information of each image receiver. The electronic device may select the image receiver of the environmental image from the plurality of stored image receivers, and obtain the attribute information of the image receiver.

In this embodiment, the electronic device may obtain an environmental video of the means of transport, and the environmental video includes a plurality of frames of environmental images.

920: Identify a compliance-related element from the environmental image.

The electronic device may identify the compliance-related element from the environmental image. In this embodiment, the environmental image includes a plurality of frames of environmental images, and the electronic device may identify a compliance-related element from each frame of environmental image.

In an embodiment, the electronic device obtains a preset compliance-related element set, and identifies a compliance-related element from the environmental image based on the preset compliance-related element set.

In an embodiment, the compliance-related element is obtained based on the preset compliance-related element set.

In this embodiment, the preset compliance-related element set may include one or more preset compliance-related elements. The electronic device may detect the environmental image, to identify whether the preset compliance-related element in the compliance-related element set exists in the environmental image, and if the preset compliance-related element in the compliance-related element set exists in the environmental image, extract an identified element, to obtain the compliance-related element in the environmental image.

Further, the electronic device may detect the environmental image, to identify each element in the environmental image. For each element in the environmental image, a similarity between the element and each preset compliance-related element in the preset compliance-related element set is determined, and if there is an element whose similarity is greater than a similarity threshold, the element is used as a compliance-related element.

In this embodiment, the electronic device may detect each element in the environmental image. For each element in the environmental image, the similarity between the element and each preset compliance-related element in the preset compliance-related element set is determined, and if there is an element whose similarity is greater than the similarity threshold, the element is used as a compliance-related element in the environmental image.

In an embodiment, the preset compliance-related element set may include preset element types of one or more preset compliance-related elements. The preset element type may be a confidential type and a desensitized type. The preset compliance-related element includes a confidentiality-related element and a desensitization-related element. The confidentiality-related element is of the confidential type, and the desensitization-related element is of the desensitized type.

The electronic device may detect the environmental image, to identify each element in the environmental image; determine whether the elements include an element that conforms to a preset element type in the compliance-related element set; and if the elements include an element that conforms to a preset element type in the compliance-related element set, extract the element that conforms to the preset element type, and use the element as a compliance-related element.

Further, the electronic device may determine an element type corresponding to each element in the environmental image, and when the element type corresponding to the element is the same as the preset element type in the compliance-related element set, use the element as a compliance-related element in the environmental image.

In this embodiment, the element type corresponding to each element in the environmental image is determined, and when the element type corresponding to the element is the same as the preset element type in the compliance-related element set, the element is used as a compliance-related element in the environmental image.

In this embodiment, the compliance-related element included in the environmental image may be identified based on the preset compliance-related element included in the preset compliance-related element set or the preset element type, and a plurality of identification manners can be provided, so that the compliance-related element is identified more quickly and comprehensively.

930: Perform compliant adjustment on the environmental image for the compliance-related element based on the attribute information, to obtain a compliant image, the compliant image being configured for generating a control instruction for the means of transport.

The electronic device may perform compliant adjustment on the environmental image for the compliance-related element based on the attribute information, to obtain the compliant image.

The compliant image is configured for generating the control instruction for the means of transport. The control instruction may be a remote control instruction.

In some embodiments, a compliant processing level may be determined based on the attribute information, and compliant adjustment is performed on the compliance-related element in the environmental image based on the compliant processing level, to obtain the compliant image.

In some embodiments, one compliant processing level may correspond to one compliant adjustment manner, and different compliant adjustment manners have different adjustment degrees. The electronic device may determine a compliant adjustment manner corresponding to the compliant processing level, and perform compliant adjustment on the compliance-related element in the environmental image in the compliant adjustment manner, to obtain the compliant image.

In an embodiment, after obtaining the compliant image, the electronic device may forward the compliant image to the image receiver, and the image receiver may play the compliant image, so that the user learns of environmental information around the means of transport. Certainly, after playing the compliant image, the image receiver may alternatively generate the control instruction based on the compliant image, and return the control instruction to the electronic device. The electronic device adjusts a driving status of the means of transport based on the control instruction in response to the control instruction, to implement control over the means of transport.

In one embodiment, the environmental image is an image in the environmental video, and the processing is performed on each frame of environmental image, to obtain each frame of compliant image. After the compliant image is obtained, all frames of compliant images are synthesized, to obtain a compliant video. The compliant video is configured for generating the control instruction for the means of transport.

In an embodiment, after obtaining the compliant video, the electronic device may forward the compliant video to the image receiver, and the image receiver may play the compliant video, so that the user learns of environmental information around the means of transport. Certainly, after playing the compliant video, the image receiver may alternatively generate the control instruction based on the compliant video, and return the control instruction to the electronic device. The electronic device adjusts a driving status of the means of transport based on the remote control instruction in response to the control instruction, to implement control over the means of transport.

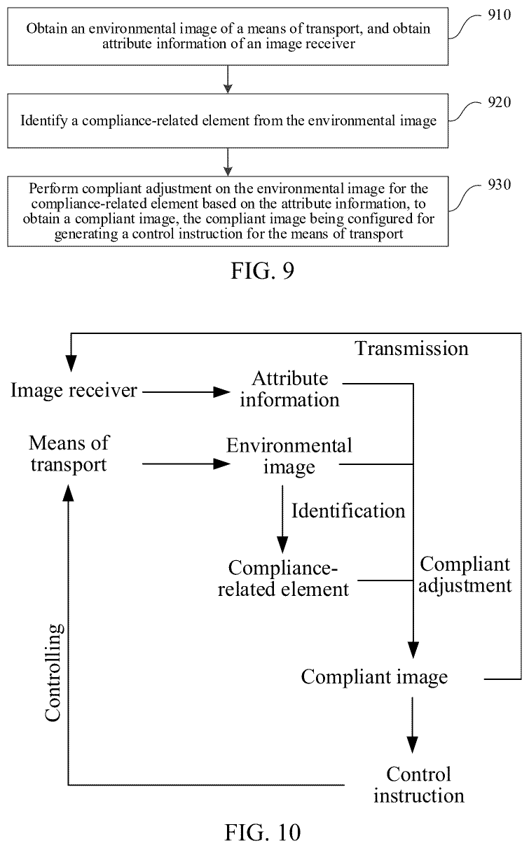

FIG. 10 is a diagram of a principle of a method for controlling a means of transport. An electronic device used in the means of transport is used as an example. The electronic device obtains an environmental image of the means of transport, and obtains attribute information of an image receiver; identifies a compliance-related element from the environmental image, and performs compliant adjustment on the environmental image for the compliance-related element based on the attribute information, to obtain a compliant image. The compliant image is configured for generating a control instruction for the means of transport. The compliant image may be transmitted to the image receiver, so that the image receiver generates the control instruction for the means of transport based on the compliant image. Alternatively, after obtaining the compliant image, the electronic device may directly generate the control instruction for the means of transport. The means of transport may be controlled based on the control instruction.

This embodiment provides the method for controlling a means of transport, performed by the electronic device. The environmental image of the means of transport is obtained, and the compliance-related element is identified from the environmental image, to determine a non-compliant element in the environmental image. Compliant adjustment needs to be performed. The attribute information of the image receiver is obtained, and compliant adjustment is performed on the environmental image for the compliance-related element based on the attribute information, to adjust an environmental image including the non-compliant element to be a compliant image. In this way, no private data exists in the compliant image received by the image receiver, thereby effectively improving confidentiality of the environmental image used in a remote control scenario of the means of transport. A current driving environment of the means of transport may be learned of based on the compliant image, so that a control instruction for the means of transport in the driving environment can be generated, to control safe driving of the means of transport in the environment, and improve control security.

In this embodiment, the method for controlling a means of transport may include: obtaining an environmental video of the means of transport, and obtaining attribute information of an image receiver, where the environmental video includes a plurality of frames of environmental images; and identifying a compliance-related element from the environmental video, and performing compliant adjustment on the environmental video for the compliance-related element based on the attribute information, to obtain a compliant video. The compliant video includes a plurality of frames of compliant images, and the compliant video is configured for generating a control instruction for the means of transport.

This embodiment provides the method for controlling a means of transport, performed by the electronic device. The environmental video of the means of transport is obtained, and the compliance-related element is identified from the environmental video, to determine a non-compliant element in the environmental video. Compliant adjustment needs to be performed. The attribute information of the video receiver is obtained, and compliant adjustment is performed on the environmental video for the compliance-related element based on the attribute information, to adjust an environmental video including the non-compliant element to be a compliant video. In this way, no private data exists in the compliant video received by the video receiver, thereby effectively improving confidentiality of the environmental video used in a remote control scenario of the means of transport. A current driving environment of the means of transport may be learned of based on the compliant video, so that a remote control instruction for the means of transport in the driving environment can be generated, to control safe driving of the means of transport in the environment, and improve remote control security.

In an embodiment, compliant adjustment includes:
classifying the attribute information, to obtain an attribute information category corresponding to the attribute information; determining a compliant processing level based on the attribute information category; and performing compliant processing based on the compliant processing level.

Classifying may be performed based on a preset attribute information classification manner. A plurality of attribute information categories and a plurality of compliant processing levels are preset, and one attribute information category may correspond to one compliant processing level.

The electronic device classifies the attribute information of the image receiver, to obtain the attribute information category corresponding to the attribute information. The electronic device determines a compliant processing level for the compliance-related element based on the attribute information category, and performs compliant adjustment on the compliance-related element in the environmental image based on the compliant processing level, to obtain the compliant image.

In this embodiment, one compliant processing level may correspond to one compliant adjustment manner. The electronic device may determine a compliant adjustment manner corresponding to the compliant processing level, and perform compliant adjustment on the compliance-related element in the environmental image in the compliant adjustment manner, to obtain the compliant image.

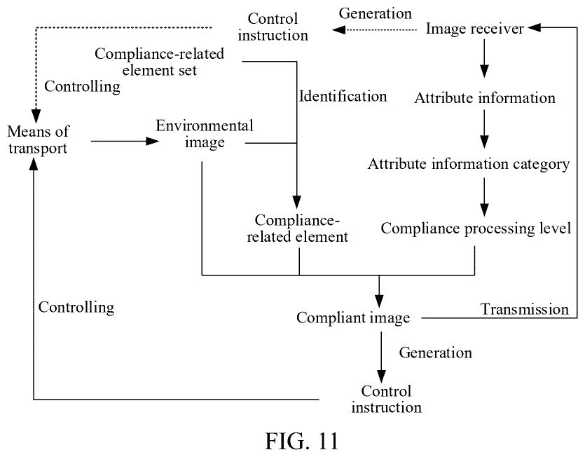

FIG. 11 is a diagram of a principle of a method for controlling a means of transport. An electronic device obtains an environmental image of the means of transport, obtains a preset compliance-related element set, and identifies a compliance-related element from the environmental image based on the compliance-related element set; obtains attribute information of an image receiver, and classifies the attribute information, to obtain an attribute information category corresponding to the attribute information; determines a compliant processing level based on the attribute information category; and performs compliant adjustment on the compliance-related element in the environmental image based on the compliant processing level, to obtain a compliant image. The compliant image may be transmitted to the image receiver, so that the image receiver generates a control instruction for the means of transport based on the compliant image. Alternatively, after obtaining the compliant image, the electronic device may directly generate a control instruction for the means of transport. The means of transport may be controlled based on the control instruction.

In this embodiment, the attribute information category corresponding to the attribute information may be determined, to determine a level of compliant processing that needs to be performed on the environmental image. A specific level of compliant processing can be performed based on a category of the attribute information of the image receiver, so that compliant adjustment is more targeted, to reduce unnecessary data processing.

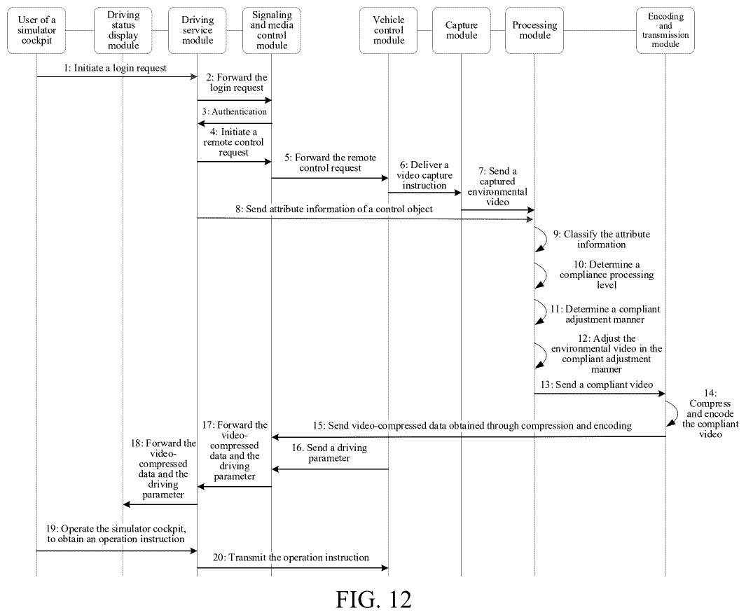

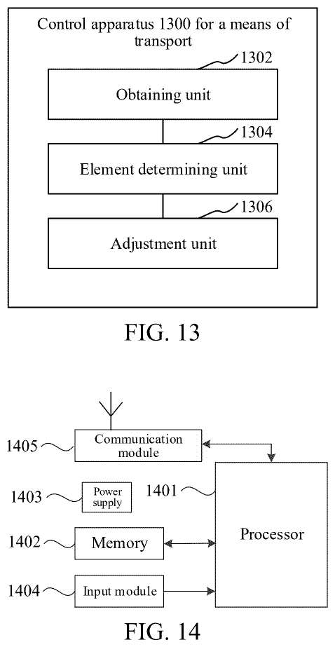

In an embodiment, the image receiver may be a control object of the means of transport, the means of transport may be a vehicle, and after receiving the compliant image, the control object may generate a remote control instruction based on the compliant image, and return the remote control instruction to the vehicle. The vehicle adjusts a driving status of the vehicle in response to the remote control instruction based on the remote control instruction, so that remote control of the control object over the vehicle is implemented. To describe a specific procedure of the remote control more clearly, FIG. 12 is a schematic diagram of data interaction of a control method. Detailed descriptions are provided below with reference to FIG. 12.

1. A user of a cockpit, namely, a control object initiates a login request for remote driving in a simulator cockpit. The login request includes a vehicle number ID-a, an identifier of the control object, and a corresponding key. The login request is transmitted to a remote service module.

2. A driving service module forwards the login request to a media and signaling control module.

3. The signaling and media control module completes authentication on the login request, and returns a response to the driving service module.

4. The driving service module starts to initiate a remote control request for a vehicle numbered ID-a to the signaling and media control module, and simultaneously performs operation 8.

5. The signaling and media control module forwards the remote control request to a vehicle control module numbered ID-a.

6. The vehicle control module issues a capture instruction to a capture module, to capture an environmental image or an environmental video of the means of transport.

7. The capture module starts to start, and transmits the captured environmental image or environmental video to a processing module.

8. A remote driving service module transmits attribute information of the control object to the image processing module.

9. The processing module classifies the attribute information, to obtain an attribute information category corresponding to the attribute information.

10. The processing module determines a compliant processing level based on the attribute information category.

11. The processing module determines a compliant adjustment manner corresponding to the compliant processing level.

12. The processing module performs compliant adjustment on a compliance-related element in the environmental image in the compliant adjustment manner, to obtain a compliant image. Alternatively, the processing module performs compliant adjustment on a compliance-related element in an environmental image in the environmental video in the compliant adjustment manner, to obtain a compliant video.

13. The processing module transmits the compliant image or the compliant video obtained through processing to an encoding and transmission module.

14. The encoding and transmission module encodes the compliant image, to obtain image-encoded data. Alternatively, the encoding and transmission module compresses and encodes the compliant video, to obtain video-compressed data.

15. The encoding and transmission module transmits the image-encoded data or the video-compressed data to a signaling and media control module of a server through a network. If only one person needs to view the compliant image or the compliant video, the image-encoded data or the video-compressed data obtained through encoding and compression may alternatively be directly transmitted to the driving service module, without being forwarded by the signaling and the media control module.

16. In this case, the vehicle control module also starts to transmit a driving parameter of the vehicle to the signaling and media control module of the server.

17. The signaling and media control module transmits the image-encoded data and the driving parameter to the driving service module. Alternatively, the signaling and media control module transmits the video-compressed data and the driving parameter to the driving service module.

18. The driving service transmits the image-encoded data and the driving parameter to a remote driving status display module together, so that the remote driving status display module presents a compliant image of a camera of a vehicle end and driving status data of the vehicle on a display. The status display module presents a compliant image of a camera of a vehicle end and driving status data of the vehicle on a display.

19. The user of the cockpit operates the simulator cockpit based on the image-encoded data and the driving parameter to start remote driving, and obtains an operation instruction for the simulator cockpit. The user of the simulator cockpit may further operate the simulator cockpit based on the video-compressed data and the driving parameter to start remote driving, and obtain an operation instruction for the simulator cockpit.

20. The operation instruction received by the driving service module is transmitted to the vehicle control module at the vehicle end through the signaling and control module at the cloud, and the vehicle control module controls vehicle driving through a CAN bus, to change a driving status of the vehicle.

Whether data that needs to be desensitized exists in the environmental image is identified, and desensitization is performed based on the attribute information of the control object according to a requirement, to avoid random leakage of private data of another person. In addition, a watermark related to the control object is added to the environmental image and the environmental video, to reduce a risk that the image and the video are spread legally. After the image and the video are spread legally, a source of the video may also be identified quickly, thereby ensuring confidentiality of the image and the video. Compliant processing on the image and the video is performed at the vehicle end, and the server does not need to perform any processing, to reduce an image and video transmission delay, and improve a response speed of the remote control.

Whether data that needs to be desensitized exists in the environmental video is identified, and desensitization is performed based on the attribute information of the control object according to a requirement, to avoid random leakage of private data of another person. In addition, a watermark related to the control object is added to the environmental video, to reduce a risk that the video is spread legally. After the video is spread legally, a source of the video may also be identified quickly, thereby ensuring confidentiality of the video. Compliant processing on the video is performed on the vehicle end, and the server does not need to perform any processing. In this way, a video transmission delay can be reduced, and a response speed of the remote control can be improved.

To better implement the foregoing method, an embodiment of this application further provides a control apparatus for a means of transport. The control apparatus may be specifically integrated into an electronic device. The electronic device may be a device such as a terminal or a server. The terminal may be a device such as a mobile phone, a tablet computer, a smart Bluetooth device, a laptop computer, a personal computer, a smart voice interaction device, a smart home appliance, a vehicle-mounted terminal, an aircraft, or a main control machine of a means of transport. The server may be a single server, or may be a server cluster including a plurality of severs.

For example, in this embodiment, an example in which a control apparatus 1300 for a means of transport is specifically integrated into an electronic device is configured for describing the method in embodiments of this application in detail.

For example, the control apparatus 1300 for a means of transport may include an obtaining unit 1302, an element determining unit 1304, and an adjustment unit 1306.

The obtaining unit 1302 is configured to obtain an environmental image of the means of transport, and obtain attribute information of an image receiver.

The element determining unit 1304 is configured to identify a compliance-related element from the environmental image based on the attribute information.

The adjustment unit 1306 is configured to perform compliant adjustment on the environmental image based on the compliance-related element, to obtain a compliant image, the compliant image being configured for generating a control instruction for the means of transport.

In an embodiment, the control apparatus further includes a control unit. The control unit is configured to adjust a driving status of the means of transport based on a control instruction in response to the control instruction triggered for a compliant video.

In an embodiment, the control unit is further configured to adjust a driving status of the means of transport based on a remote control instruction in response to the remote control instruction triggered for a compliant video.

In this embodiment, the environmental image of the means of transport and the attribute information of the image receiver are obtained, and the compliance-related element is identified from the environmental image based on the attribute information, to identify a non-compliant element in the environmental image. Compliant adjustment needs to be performed, to adjust the environmental image including the non-compliant element to the compliant image. In this way, private data does not exist in the compliant image received by the image receiver, and confidentiality of the environmental image used in a control scenario of the means of transport is effectively improved. A current driving environment of the means of transport may be learned of based on the compliant image, so that a control instruction for the means of transport in the driving environment can be generated, to control safe driving of the means of transport in the environment, and improve control security.

In addition, an object that controls the means of transport may trigger the control instruction after viewing the compliant image, and the electronic device adjusts the driving status of the means of transport based on the control instruction. In this way, not only control of the object over the means of transport can be implemented, but also leakage of private data in a control process of the means of transport can be avoided. In addition, private data does not exist in the compliant image seen by the object that controls the means of transport, thereby effectively improving confidentiality of an environmental image used in a control scenario of the means of transport.

In an embodiment, the adjustment unit is further configured to: obtain a preset element having a mapping relationship with the attribute information; and
perform compliant adjustment on the environmental image based on the compliance-related element in the environmental image and the preset element, to obtain the compliant image.

In some embodiments, the attribute information includes an object type, and the element determining unit 1304 further includes:
a mapping obtaining subunit, configured to obtain a mapping relationship between a preset object type and a preset element; and
a determining subunit, configured to obtain, based on the mapping relationship, the preset element onto which the object type is mapped.

In this embodiment, setting the mapping relationship between an object type and a preset element can set respective preset elements for different types of objects. In this way, the preset element is set in a targeted manner. An element onto which the object type is mapped is found based on the mapping relationship and is used as the preset element of the environmental video. In this way, the preset element is queried more quickly and more accurately, to help improve a speed and quality compliant adjustment on the environmental video.

In some implementations, the preset element includes a plurality of identification elements, the identification elements are configured for marking a source of the environmental video, the compliance-related element includes a confidentiality-related element, and the element determining unit 1304 is further configured to: determine an arrangement rule of the plurality of identification elements for the environmental image; and identify confidentiality-related elements respectively corresponding to the plurality of identification elements in the environmental image based on the arrangement rule for the environmental image and the plurality of identification elements.

In this embodiment, the arrangement rule of the plurality of identification elements for each frame of environmental image is determined. For each frame of environmental image, identification regions respectively corresponding to the plurality of identification elements are determined in the environmental image based on the arrangement rule for the environmental image and the plurality of identification elements. In this way, the plurality of identification elements may be arranged in the environmental image based on different arrangement rules, so that the source of the environmental image is marked in a plurality of manners, to improve security of each frame of environmental image in the environmental video.

In some embodiments, the element determining unit 1304 is further configured to: arrange the plurality of identification elements in the environmental image based on the arrangement rule for the environmental image, to obtain an arranged environmental image; and determine that regions respectively overlapping the plurality of identification elements in the arranged environmental image are the confidentiality-related elements respectively corresponding to the plurality of identification elements.

In this embodiment, for each frame of environmental image, the plurality of identification elements are arranged in the environmental image based on the arrangement rule for the environmental image, to obtain an image including the plurality of identification elements. Regions respectively overlapping the plurality of identification elements in the arranged environmental image are determined as the identification regions respectively corresponding to the plurality of identification elements. In this way, identification regions of the plurality of identification elements in different environmental images can be determined based on the arrangement rule, so that an image source of each frame of environmental image in the environmental video is marked based on different arrangement rules. There are more complex and diversified source marking manners, and the source of each frame of environmental image can be traced, so that security is higher.

In some implementations, the preset element includes a masking element, the compliance-related element includes a desensitization-related element, and the element determining unit 1304 is further configured to: detect a to-be-masked object corresponding to the masking element in each frame of environmental image, and use the to-be-masked object in the environmental image as a desensitization-related element.

In some embodiments, the adjustment unit 1306 is further configured to perform a frequency-domain transform on the identification element, to obtain an adjusted identification element; and fusing the adjusted identification element and the confidentiality-related element in the environmental image, to obtain the compliant image.

In some embodiments, the adjustment unit 1306 is further configured to synthesize all frames of compliant images, to obtain a compliant video.

In this embodiment, the frequency-domain transform is performed on the identification element, to transform the identification element from the spatial domain to the specified frequency domain, to improve robustness and confidentiality of the identification element. The adjusted identification element and the identification region in the environmental image are fused, to obtain a fused environmental image. In this way, an environmental image whose source is marked by using the identification element is obtained. All frames of environmental images whose sources are marked are synthesized to obtain a compliant video whose source is marked.

In some embodiments, the adjustment unit 1306 is further configured to: perform a frequency-domain transform on the confidentiality-related element in the environmental image, to obtain a transformed region image; fuse the adjusted identification element and the transformed region image, to obtain a region-fused image; and transform the region-fused image into a spatial domain, to obtain the compliant image.

In this embodiment, the frequency-domain transform is performed on the identification region in each frame of environmental image, so that robustness and confidentiality of the identification region can be improved. The adjusted identification element and the transformed region image are fused, to obtain the region-fused image, the region-fused image is transformed into the spatial domain, to obtain the fused environmental image, and all the frames of images are synthesized, to obtain the compliant video, so that the compliant video includes an identification element related to a control object, to reduce a risk of legally spreading the compliant video, effectively protect the video, and improve video confidentiality. A source may be efficiently traced after the compliant video is legally spread.

In some embodiments, the adjustment unit 1306 is further configured to blur the desensitization-related element in the environmental image based on the masking element, to obtain the compliant image.

In some embodiments, the adjustment unit 1306 is further configured to synthesize all frames of compliant images, to obtain a compliant video.

In this embodiment, for each frame of environmental image, the desensitization-related element in the environmental image is blurred by using the masking element, so that private data of another person in the environmental image can be masked. All frames of blurred environmental images are synthesized, to obtain a compliant video including no private data of the another person, thereby effectively protecting privacy of the another person.

In some embodiments, the adjustment unit 1306 is further configured to: obtain color information and shape information of the desensitization-related element in the environmental image; adjust a shape and a color of the masking element based on the shape information and the color information of the desensitization-related element in the environmental image, to obtain a corrected masking element; and cover the desensitization-related element in the environmental image with the corrected masking element, to obtain the compliant image.

In this embodiment, for each frame of fused environmental image, boundary information of a to-be-masked region is obtained, and the boundary information of the masking element is corrected based on the boundary information in the environmental image, so that a boundary of the corrected masking element fits a boundary of the to-be-masked region, and the corrected masking element can completely cover the to-be-masked region in the environmental image, thereby accurately masking the private data of the another person. In addition, the boundary of the corrected masking element fits the boundary of the to-be-masked region, so that the masking element is more naturally fused into the environmental image, to improve a visual effect.

In some embodiments, the adjustment unit 1306 is further configured to: for each frame of fused environmental image, obtain color information and shape information of a desensitization-related element; adjust a shape of the masking element based on the shape information, to obtain an adjusted masking element; correct a color of the adjusted masking element based on the color information, to obtain a corrected masking element; and cover the corrected masking element with a desensitization-related element, to obtain a compliant image.

In this embodiment, the color information and the shape information of the desensitization-related element in the environmental image are obtained, to adjust the shape of the masking element based on the shape information of the desensitization-related element, and adjust the color of the masking element based on the color information of the desensitization-related element, so that the adjusted masking element can accurately mask the private data in the environmental image, and can be more naturally fused into the environmental image in terms of the shape and the color. In this way, the visual effect is improved.

In some embodiments, the control unit further includes:
a parameter obtaining subunit, configured to obtain a driving parameter of the means of transport;
an encoding subunit, configured to encode the compliant image, to obtain an image-encoded data;
an instruction obtaining subunit, configured to transmit the driving parameter and the image-encoded data to a server, to display the driving parameter and the compliant image to the image receiver; and
a control subunit, configured to: obtain, through the server, a control instruction generated by the image receiver based on the driving parameter and the compliant image, and adjust the driving parameter of the means of transport based on the control instruction, to adjust a driving status of the means of transport.

In some embodiments, the compliant image is an image in a compliant video, and the encoding subunit is further configured to:
analyze a plurality of frames of compliant images in the compliant video, and determine a frame type of each frame of compliant image; and
encode, when a frame type of a compliant image is a preset type, the compliant image based on a spatial correlation between pixels in the compliant image, to obtain image-encoded data; or
encode, when a frame type of a compliant image is not the preset type, the compliant image based on temporal repeatability of all frames of compliant images that are not of the preset type, to obtain image-encoded data.

In some embodiments, the electronic device is mounted on the means of transport, and the apparatus further includes:
a receiving module, configured to receive a remote control request initiated by the control object for the means of transport through a simulator cockpit; and
a transmission module, configured to transmit the compliant image to the simulator cockpit.

The receiving module is further configured to receive a control instruction initiated by the control object through the simulated driving, the control instruction being generated by the control object after the control object browses the compliant image in the simulated driving.

In this embodiment, when receiving the remote control request initiated by the user, the electronic device mounted on the means of transport automatically captures an environment around the means of transport to generate a video, and automatically performs compliant adjustment on the environmental video, to protect private data in the video. After being adjusted, the video is transmitted to the user, so that after viewing the video, the user may transmit the remote control instruction in a targeted manner to control driving of the means of transport, thereby improving security of data in the video, and ensuring safety of remote driving.

In an embodiment, the control apparatus 1300 for a means of transport may include an obtaining unit 1302, an element determining unit 1304, and an adjustment unit 1306.

The obtaining unit 1302 is configured to obtain an environmental image of the means of transport, and obtain attribute information of an image receiver.

The element determining unit 1304 is configured to identify a compliance-related element from the environmental image.

The adjustment unit 1306 is configured to perform compliant adjustment on the environmental image for the compliance-related element based on the attribute information, to obtain a compliant image, the compliant image being configured for generating a control instruction for the means of transport.

In an embodiment, the adjustment unit 1306 is further configured to: classify the attribute information, to obtain an attribute information category corresponding to the attribute information; determine a compliant processing level based on the attribute information category; and perform compliant processing based on the compliant processing level.

During specific implementation, the foregoing units may be implemented as independent entities, or may be randomly combined, or may be implemented as the same entity or several entities. For specific implementation of the foregoing units, refer to the foregoing method embodiments. Details are not described herein again.

An embodiment of this application further provides an electronic device. The electronic device may be a device such as a terminal or a server. The terminal may be a mobile phone, a tablet computer, a smart Bluetooth device, a laptop computer, a personal computer, a smart voice interaction device, a smart home appliance, a vehicle-mounted terminal, an aircraft, a main control machine of a means of transport, or the like. The server may be a single server, or may be a server cluster including a plurality of severs.

In some embodiments, the control apparatus for a means of transport may alternatively be integrated into a plurality of electronic devices. For example, the control apparatus for a means of transport may be integrated into a plurality of servers, and the plurality of servers implement the method for controlling a means of transport in this application.

In this embodiment, an example in which the electronic device in this embodiment is a main control machine of a vehicle is used for detailed descriptions. For example, FIG. 4 is a schematic structural diagram of an electronic device according to an embodiment of this application. Details are as follows.

The electronic device may include components such as a processor 1401 including one or more processing cores, a memory 1402 including one or more computer-readable storage media, a power supply 1403, an input module 1404, and a communication module 1405. A person skilled in the art may understand that the structure of the electronic device shown in FIG. 14 does not constitute a limitation to the electronic device, and the electronic device may include more or fewer components than those illustrated, or a combination of some components, or have a different arrangement of components.

The processor 1401 is a control center of the electronic device, is connected to various parts of the entire electronic device by using various interfaces and lines, runs or executes a software program and/or module stored in the memory 1402, and invokes data stored in the memory 1402, to perform various functions of the electronic device and processes data, so as to detect the entire electronic device. In some embodiments, the processor 1401 may include one or more processing cores. In some embodiments, the processor 1401 may integrate an application processor and a modem processor. The application processor mainly processes an operating system, a user interface, an application program, and the like. The modem processor mainly processes wireless communication. The modem processor may not be integrated into the processor 1401.

The memory 1402 may be configured to store a software program and module. The processor 1401 runs the software program and module stored in the memory 1402, to perform various functional applications and data processing. The memory 1402 may mainly include a program storage area and a data storage area. The program storage area may store an operating system, an application program required by at least one function (such as a sound playback function and an image display function), and the like. The data storage area may store data created according to use of the electronic device, and the like. In addition, the memory 1402 may include a high-speed random access memory, and may also include a non-volatile memory, such as at least one magnetic disk storage device, a flash memory, or another volatile solid-state memory. Correspondingly, the memory 1402 may further include a memory controller, so as to provide access of the processor 1401 to the memory 1402.

The electronic device further includes the power supply 1403 for supplying power to the components. In some embodiments, the power supply 1403 may be logically connected to the processor 1401 by using a power supply management system, thereby implementing functions, such as charging, discharging, and power consumption management, by using the power supply management system. The power supply 1403 may further include one or more of a direct current or alternating current power supply, a re-charging system, a power failure detection circuit, a power supply converter or inverter, a power supply state indicator, and any other components.

The electronic device may further include the input module 1404. The input module 1404 may be configured to receive input digit or character information and generate a keyboard, mouse, joystick, optical, or trackball signal input related to the user setting and function control.

The electronic device may further include the communication module 1405. In some embodiments, the communication module 1405 may include a wireless module. The electronic device may perform short-distance wireless transmission through the wireless module in the communication module 1405, to provide the user with wireless broadband Internet access. The communication module 1405 may be configured to help the user to receive and transmit e-mails, browse a webpage, access streaming media, and the like.

Although not shown in the figure, the electronic device may further include a display unit and the like. Details are not described herein. Specifically, in this embodiment, the processor 1401 in the electronic device loads executable files corresponding to processes of the one or more applications to the memory 1402 according to the following instructions, and the processor 1401 runs the application in the memory 1402, to implement various functions, which are as follows:
obtaining an environmental image of a means of transport, and obtaining attribute information of an image receiver; identifying a compliance-related element from the environmental image based on the attribute information; and performing compliant adjustment on the environmental image based on the compliance-related element, to obtain a compliant image, the compliant image being configured for generating a control instruction for the means of transport.

For specific implementations of each of the foregoing operations, refer to the foregoing embodiments. Details are not described herein again.

A preset element is determined based on attribute information of a control object, and then compliant processing is performed on the environmental video by using the preset element, so that content of the video can be protected, to prevent random leakage of private data of another person, and effectively improve confidentiality of the video in remote control.

A person of ordinary skill in the art may understand that, all or some operations of the methods in the foregoing embodiments may be implemented by using instructions, or implemented through instructions controlling relevant hardware, and the instructions may be stored in a non-transitory computer-readable storage medium and loaded and executed by a processor.

In view of this, an embodiment of this application provides a non-transitory computer-readable storage medium, having a plurality of computer-readable instructions stored therein, the computer-readable instructions, when executed by a processor, performing the operations in the method embodiments of this application.

The storage medium may include: a read-only memory (ROM), a random access memory (RAM), a magnetic disk, an optical disc, or the like.

According to an aspect of this application, a computer program product is provided, the computer program product or a computer program including computer instructions, the computer instructions being stored in a non-transitory computer-readable storage medium. A processor of an electronic device reads the computer instructions from the computer-readable storage medium, and the processor performs the computer instructions, so that the electronic device performs the methods provided in the foregoing various implementations of a remote control aspect in the foregoing embodiments.

Because the computer-readable instructions stored in the storage medium can be configured for performing operations in any method for controlling a means of transport provided in the embodiments of this application, the computer-readable instructions can achieve beneficial effects that can be implemented by any method for controlling a means of transport provided in the embodiments of this application. For details, refer to the foregoing embodiments, and details are not described herein.

The control method and apparatus for a means of transport, the electronic device, the storage medium, and the program product provided in the embodiments of this application are described above in detail. Although the principles and implementations of this application are described by using specific examples in this specification, the foregoing descriptions of the embodiments are merely intended to help understand the method and core idea of this application. Moreover, a person skilled in the art may make modifications to the specific implementations and application range according to the idea of this application. In conclusion, the content of the specification is not to be construed as a limitation to this application.

Technical features of the foregoing embodiments may be combined in different manners to form other embodiments. To make description concise, not all possible combinations of the technical features in the foregoing embodiments are described. However, the combinations of these technical features shall be considered as falling within the scope set forth in this specification provided that no conflict exists.

In this application, the term “module” or “unit” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each unit or module can be implemented using one or more processors (or processors and memory). Likewise, a processor (or processors and memory) can be used to implement one or more modules or units. Moreover, each module or unit can be part of an overall module that includes the functionalities of the module or unit. The foregoing embodiments only describe several implementations of this application specifically and in detail, but cannot be construed as a limitation to the patent scope of this application. A person of ordinary skill in the art may further make variations and improvements without departing from the concept of this application, and the variations and improvements shall fall within the protection scope of this application. Therefore, the patent protection scope of this application shall be subject to the appended claims.

What is claimed is:

1. A method for controlling a means of transport performed by an electronic device, the method comprising:
obtaining an environmental image of the means of transport and attribute information of an image receiver;
identifying a compliance-related element from the environmental image based on the attribute information;
performing compliant adjustment on the environmental image based on the compliance-related element, to obtain a compliant image; and
generating a control instruction for the means of transport based on the compliant image.

2. The method according to claim 1, wherein the performing compliant adjustment on the environmental image based on the compliance-related element, to obtain a compliant image comprises:
obtaining a preset element having a mapping relationship with the attribute information; and
performing compliant adjustment on the environmental image based on the compliance-related element in the environmental image and the preset element, to obtain the compliant image.

3. The method according to claim 2, wherein the preset element comprises a plurality of identification elements, each identification element is configured for marking a source of the environmental image, the compliance-related element comprises a confidentiality-related element, and the identifying a compliance-related element from the environmental image based on the attribute information comprises:
determining an arrangement rule of the plurality of identification elements for the environmental image; and
identifying confidentiality-related elements respectively corresponding to the plurality of identification elements in the environmental image based on the arrangement rule for the environmental image and the plurality of identification elements.

4. The method according to claim 3, wherein the identifying confidentiality-related elements respectively corresponding to the plurality of identification elements in the environmental image based on the arrangement rule for the environmental image and the plurality of identification elements comprises:
arranging the plurality of identification elements in the environmental image based on the arrangement rule for the environmental image, to obtain an arranged environmental image; and
determining that regions respectively overlapping the plurality of identification elements in the arranged environmental image are the confidentiality-related elements respectively corresponding to the plurality of identification elements.

5. The method according to claim 3, wherein the performing compliant adjustment on the environmental image based on the compliance-related element in the environmental image and the preset element, to obtain the compliant image comprises:
performing a frequency-domain transform on the identification element, to obtain an adjusted identification element; and
fusing the adjusted identification element and the confidentiality-related element in the environmental image, to obtain the compliant image.

6. The method according to claim 2, wherein the preset element comprises a masking element, the compliance-related element comprises a desensitization-related element, and the performing compliant adjustment on the environmental image based on the compliance-related element in the environmental image and the preset element, to obtain the compliant image comprises:
blurring the desensitization-related element in the environmental image based on the masking element, to obtain the compliant image.

7. The method according to claim 1, further comprising:
obtaining a driving parameter of the means of transport;
encoding the compliant image, to obtain an image-encoded data;
transmitting the driving parameter and the image-encoded data to a server, to display the driving parameter and the compliant image to the image receiver; and
obtaining, through the server, a control instruction generated by the image receiver based on the driving parameter and the compliant image, and adjusting the driving parameter of the means of transport based on the control instruction, to adjust a driving status of the means of transport.

8. The method according to claim 7, wherein the environmental image is an image in an environmental video of the means of transport, the compliant image is an image in a compliant video, the compliant video is obtained by performing compliant adjustment on the environmental image in the environmental video, and the encoding the compliant image, to obtain an image-encoded data comprises:
analyzing a plurality of frames of compliant images in the compliant video, and determining a frame type of each frame of compliant image;
encoding, when a frame type of a compliant image is a preset type, the compliant image based on a spatial correlation between pixels in the compliant image, to obtain image-encoded data; and
encoding, when a frame type of a compliant image is not the preset type, the compliant image based on temporal repeatability of all frames of compliant images that are not of the preset type, to obtain image-encoded data.

9. The method according to claim 1, wherein the electronic device is mounted in the means of transport, the image receiver comprises a control object, the control object is an object that controls the means of transport, and before the obtaining an environmental image of the means of transport, the method further comprises:
receiving a control request initiated by the control object for the means of transport through a simulator cockpit; and
after the performing compliant adjustment on the environmental image based on the compliance-related element, to obtain a compliant image, the method further comprises:
transmitting the compliant image to the simulator cockpit; and
receiving a control instruction initiated by the control object through the simulated driving, the control instruction being generated by the control object after the control object browses the compliant image in the simulated driving.

10. An electronic device, comprising a processor and a memory, the memory having a plurality of instructions stored therein, and the instructions from the memory, when executed by the processor, causing the electronic device to perform a method for controlling a means of transport including:
obtaining an environmental image of the means of transport and attribute information of an image receiver;
identifying a compliance-related element from the environmental image based on the attribute information;
performing compliant adjustment on the environmental image based on the compliance-related element, to obtain a compliant image; and
generating a control instruction for the means of transport based on the compliant image.

11. The electronic device according to claim 10, wherein the performing compliant adjustment on the environmental image based on the compliance-related element, to obtain a compliant image comprises:
obtaining a preset element having a mapping relationship with the attribute information; and
performing compliant adjustment on the environmental image based on the compliance-related element in the environmental image and the preset element, to obtain the compliant image.

12. The electronic device according to claim 11, wherein the preset element comprises a plurality of identification elements, each identification element is configured for marking a source of the environmental image, the compliance-related element comprises a confidentiality-related element, and the identifying a compliance-related element from the environmental image based on the attribute information comprises:
determining an arrangement rule of the plurality of identification elements for the environmental image; and
identifying confidentiality-related elements respectively corresponding to the plurality of identification elements in the environmental image based on the arrangement rule for the environmental image and the plurality of identification elements.

13. The electronic device according to claim 12, wherein the identifying confidentiality-related elements respectively corresponding to the plurality of identification elements in the environmental image based on the arrangement rule for the environmental image and the plurality of identification elements comprises:
arranging the plurality of identification elements in the environmental image based on the arrangement rule for the environmental image, to obtain an arranged environmental image; and
determining that regions respectively overlapping the plurality of identification elements in the arranged environmental image are the confidentiality-related elements respectively corresponding to the plurality of identification elements.

14. The electronic device according to claim 12, wherein the performing compliant adjustment on the environmental image based on the compliance-related element in the environmental image and the preset element, to obtain the compliant image comprises:
performing a frequency-domain transform on the identification element, to obtain an adjusted identification element; and
fusing the adjusted identification element and the confidentiality-related element in the environmental image, to obtain the compliant image.

15. The electronic device according to claim 11, wherein the preset element comprises a masking element, the compliance-related element comprises a desensitization-related element, and the performing compliant adjustment on the environmental image based on the compliance-related element in the environmental image and the preset element, to obtain the compliant image comprises:
blurring the desensitization-related element in the environmental image based on the masking element, to obtain the compliant image.

16. The electronic device according to claim 10, wherein the method further comprises:
obtaining a driving parameter of the means of transport;
encoding the compliant image, to obtain an image-encoded data;
transmitting the driving parameter and the image-encoded data to a server, to display the driving parameter and the compliant image to the image receiver; and
obtaining, through the server, a control instruction generated by the image receiver based on the driving parameter and the compliant image, and adjusting the driving parameter of the means of transport based on the control instruction, to adjust a driving status of the means of transport.

17. The electronic device according to claim 16, wherein the environmental image is an image in an environmental video of the means of transport, the compliant image is an image in a compliant video, the compliant video is obtained by performing compliant adjustment on the environmental image in the environmental video, and the encoding the compliant image, to obtain an image-encoded data comprises:
analyzing a plurality of frames of compliant images in the compliant video, and determining a frame type of each frame of compliant image;
encoding, when a frame type of a compliant image is a preset type, the compliant image based on a spatial correlation between pixels in the compliant image, to obtain image-encoded data; and
encoding, when a frame type of a compliant image is not the preset type, the compliant image based on temporal repeatability of all frames of compliant images that are not of the preset type, to obtain image-encoded data.

18. The electronic device according to claim 10, wherein the electronic device is mounted in the means of transport, the image receiver comprises a control object, the control object is an object that controls the means of transport, and before the obtaining an environmental image of the means of transport, the method further comprises:
receiving a control request initiated by the control object for the means of transport through a simulator cockpit; and
after the performing compliant adjustment on the environmental image based on the compliance-related element, to obtain a compliant image, the method further comprises:
transmitting the compliant image to the simulator cockpit; and
receiving a control instruction initiated by the control object through the simulated driving, the control instruction being generated by the control object after the control object browses the compliant image in the simulated driving.

19. A non-transitory computer-readable storage medium, having a plurality of instructions stored therein, the instructions, when executed by a processor of an electronic device, causing the electronic device to perform a method for controlling a means of transport including:
obtaining an environmental image of the means of transport and attribute information of an image receiver;
identifying a compliance-related element from the environmental image based on the attribute information;
performing compliant adjustment on the environmental image based on the compliance-related element, to obtain a compliant image; and
generating a control instruction for the means of transport based on the compliant image.

20. The non-transitory computer-readable storage medium according to claim 19, wherein the performing compliant adjustment on the environmental image based on the compliance-related element, to obtain a compliant image comprises:
obtaining a preset element having a mapping relationship with the attribute information; and
performing compliant adjustment on the environmental image based on the compliance-related element in the environmental image and the preset element, to obtain the compliant image.
